(19) United States
(12) Patent Application Publication
(10) Pub. No.: US 2015/0078367 A1
(43) Pub. Date: Mar. 19, 2015

(54) COMMUNICATIONS DEVICE, COMPUTER PRODUCT, AND COMMUNICATION CONTROL METHOD

(71) Applicant: FUJITSU LIMITED, Kawasaki-shi (JP)

(72) Inventors: Yasushi HARA, Kunitachi (JP); Takashi IWABUCHI, Kawasaki (JP); Masaaki KITAGUCHI, Kasugai (JP); Yoshitaka NAKAGAWA, Kawasaki (JP); Akemi TOYOKURA, Kawasaki (JP); Yuichi MIURA, Sapporo (JP)

(73) Assignee: FUJITSU LIMITED, Kawasaki-shi (JP)

(21) Appl. No.: 14/554,560

(22) Filed: Nov. 26, 2014

Related U.S. Application Data
(63) Continuation of application No. PCT/JP2012/064238, filed on May 31, 2012.

(51) Int. Cl. H04W 48/16

(52) U.S. Cl. CPC H04W 48/16
USPC 370/338

(57) ABSTRACT

A communications device includes a processor configured to detect a wirelessly communicating base station, using a given interval; determine whether identification information of the detected base station matches identification information of a base station detected last time; and set the given interval to a second interval upon determining that the identification information of the detected base station and the identification information of the base station detected last time match. The second interval is longer than a first interval that is set upon determining that the identification information of the detected base station and the identification information of the base station detected last time do not match.

### CROSS REFERENCE TO RELATED APPLICATIONS

This application is a continuation application of International Application PCT/JP2012/064238, filed on May 31, 2012 and designating the U.S., the entire contents of which are incorporated herein by reference.

### FIELD

The embodiments discussed herein are related to a communications device, a computer product, and a communication control method.

### BACKGROUND

A conventional communications device such as a smartphone and a mobile telephone has a communication function of connecting to a wireless local area network (LAN) and can further connect to a network such as the Internet via wireless LAN base stations disposed at various locations, for example.

Related technologies include a technique of saving electric power in consideration of movement speed of a wireless mobile terminal in a wireless LAN system, for example, as well as a technique for reducing electric power of an unnecessary cell search outside a wireless LAN area by turning on/off a wireless LAN power source linked to a public wireless base station area. For examples, refer to Japanese Laid-Open Patent Publication Nos. 2008-066892 and 2009-201104.

Nonetheless, conventional techniques have a problem of causing an increase in power consumption of a communications device due to the periodic scanning operation of searching for a base station acting as a base for connecting to a network.

### SUMMARY

According to an aspect of an embodiment, a communications device includes a processor configured to detect a wirelessly communicating base station, using a given interval; determine whether identification information of the detected base station matches identification information of a base station detected last time; and set the given interval to a second interval upon determining that the identification information of the detected base station and the identification information of the base station detected last time match. The second interval is longer than a first interval that is set upon determining that the identification information of the detected base station and the identification information of the base station detected last time do not match.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a communication control method according to a first embodiment;

FIG. 2 is an explanatory diagram of a system configuration example of a communication system 200;

FIG. 3 is a block diagram of a hardware configuration example of a communications device 101;

FIG. 4 is an explanatory diagram of an example of the contents stored by a connection recording table 400;

FIG. 5 is an explanatory diagram of an example of the contents stored by an AP flag table 500;

FIG. 6 is an explanatory diagram of an example of the contents of an ESSID list 600;

FIG. 7 is a block diagram of a functional configuration of the communications device 101;

FIG. 8 is an explanatory diagram (part one) of an operation example of the communications device 101 according to the first embodiment;

FIG. 9 is an explanatory diagram (part two) of an operation example of the communications device 101 according to the first embodiment;

FIG. 10 is an explanatory diagram (part three) of an operation example of the communications device 101 according to the first embodiment;

FIG. 11 is an explanatory diagram (part four) of an operation example of the communications device 101 according to the first embodiment;

FIG. 12 is an explanatory diagram (part five) of an operation example of the communications device 101 according to the first embodiment;

FIG. 13 is an explanatory diagram of a change example of a given interval T;

FIG. 14 is a flowchart of an example of a first communication control process procedure of the communications device 101 according to the first embodiment;

FIG. 15 is a flowchart of an example of a second communication control process procedure of the communications device 101 according to the first embodiment;

FIG. 16 is a flowchart of an example a scan flag change process procedure of the communications device 101 according to the first embodiment;

FIG. 17 is a flowchart of an example of a third communication control process procedure of the communications device 101 according to the first embodiment;

FIG. 18 is an explanatory diagram of an example of a scanning operation of detecting an access point APj;

FIG. 19 is a block diagram of a functional configuration of the communications device 101;

FIG. 20 is an explanatory diagram (part one) of an operation example of the communications device 101 according to a second embodiment;

FIG. 21 is an explanatory diagram (part one) of an operation example of the communications device 101 according to the second embodiment;

FIG. 22 is an explanatory diagram (part three) of an operation example of the communications device 101 according to the second embodiment;

FIG. 23 is an explanatory diagram (part four) of an operation example of the communications device 101 according to the second embodiment; and

FIG. 24 is a flowchart of an example of a second communication control process procedure of the communications device 101 according to the second embodiment.

### DESCRIPTION OF EMBODIMENTS

Embodiments of a communications device, a computer product, and a communication control method will be described in detail with reference to the accompanying drawings.

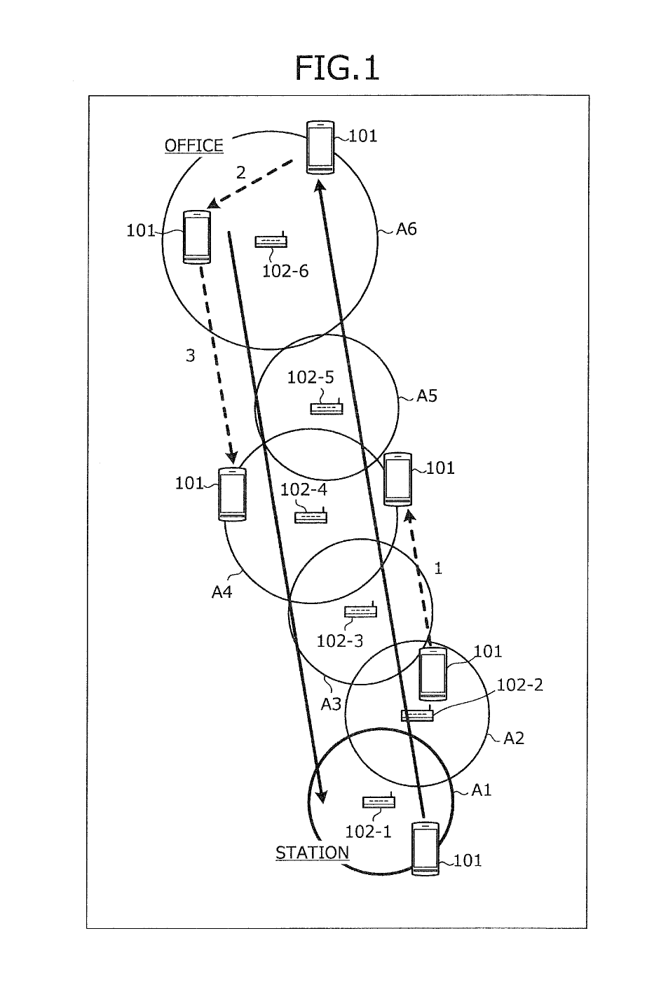

FIG. 1 is an explanatory diagram of an example of a communication control method according to a first embodiment. In FIG. 1, the communications device 101 is a computer that is configured to wirelessly communicate with a base station 102. For example, the communications device 101 may be a smartphone, a mobile telephone, a tablet-type personal computer (PC), or a personal handy-phone system (PHS) device.

The base station 102 is a wireless station that is configured to wirelessly communicate with the communications device 101 present within the communication area of the base station 102. For example, the base station 102 is an access point of a wireless local area network (LAN) or a base station of a mobile communications network (mobile telephone network) provided at various locations.

The communications device 101 can detect the wirelessly communicating base station 102 and connect to a network, via the detected base station 102. Therefore, the base station 102 is a wireless station acting as a base for the communications device 101 to connect to a network. For example, the network may be a LAN, a wide area network (WAN), the Internet, or a mobile communications network.

Some of the base stations 120 are available only to users subscribing to a certain service, for example. Therefore, the communications device 101 connects to the network via the base station 102 available to a user of the communications device 101, among the detected base stations 102.

Detection operation of the communications device 101 detecting the wirelessly communicating base station 102 is a so-called scanning operation of searching for a communicable base station 102 and is performed at a given interval, for example. When the given interval is shorter, re-connectivity to the base station 102 becomes higher although this leads to an increase in the power consumption of the communications device 101. When the given interval is longer, the power consumption of the communications device 101 can be suppressed although re-connectivity to the base station 102 becomes lower. Re-connectivity to the base station 102 represents the shortness of the time until connection to the available base station 102, for example.

In the first embodiment, the communications device 101 detects the base station 102 at a given interval T and acquires identification information of the detected base station 102. The communications device 101 determines whether the acquired identification information of the base station 102 matches the identification information acquired the last time. The communications device 101 changes the given interval T based on a result of the determination.

If the identification information acquired this time does not match the identification information acquired last time, the communications device 101 is present in a communication area different from that during the previous period. Therefore, the communications device 101 can determine that the user of the communications device 101 has moved from the communication area to which the user belonged during the previous period.

On the other hand, if the identification information acquired this time matches the identification information acquired last time, the communications device 101 is present in the same communication area as that of the previous period. Therefore, the communications device 101 can determine that the user of the communications device 101 has not moved from the communication area of the previous period.

If the user of the communications device 101 moves, the user may move into the communication area of a base station 102 available to the communications device 101. On the other hand, if the user does not move from the communication area of a base station 102 unavailable to the communications device 101, the detection operation for the base station 102 by the communications device 101 is not desirable in terms of electric power.

Therefore, if the base station 102 identification information acquired this time matches the base station 102 identification information acquired last time, the communications device 101 sets the given interval T to an interval T2 longer than an interval T1 set in the case of mismatch of the identification information of the base station 102. A communication control process example of the communications device 101 according to the first embodiment will hereinafter be described.

In the example of FIG. 1, base stations 102-1 to 12-6 are depicted as the base stations 102 along with communication areas A1 to A6 of the base stations 102-1 to 102-6. For example, the base station 102-1 is disposed in front of a train station and the base stations 102-1 to 102-5 are disposed between the train station and an office, while the base station 102-6 is disposed at a company.

The base station 102-1 is a base station 102 available to the user of the communications device 101 and is a base station 102 having a record of connection of the communications device 101. A record of connection represents a history of proper completion of a process to connect to the base station 102 by the communications device 101. The connection process is a process of connecting to the network, via the base station 102. For example, an authentication process for the user of the communications device 101 is executed in the connection process.

For instance, in an example indicated by 1 in FIG. 1, the user of the communications device 101 moves from the communication area A2 of the base station 102-2 to the communication area A4 of the base station 102-4 on the way from the train station to the company. It is assumed that the base station 102-4 is detected after the given interval T has elapsed from the detection of the base station 102-2.

In this case, the communications device 101 acquires the identification information of the detected base station 102-4. The communications device 101 determines whether the identification information of the base station 102-4 acquired this time matches the identification information of the base station 102-2 acquired last time. In this example, the identification information of the base station 102-4 does not match the identification information of the base station 102-2.

Therefore, the communications device 101 determines that the identification information of the base station 102-4 acquired this time does not match the identification information of the base station 102-2 acquired last time, and sets the given interval T to the interval T1. In other words, the communications device 101 decides that the user is moving, and sets the given interval T to the interval T1, which is shorter than the interval T2 set when the user is not moving.

In an example indicated by 2 in FIG. 1, the user of the communications device 101 is working at the company and therefore, does not move from the communication area A6 of the base station 102-6 even when the given interval T has elapsed.

In this case, the communications device 101 acquires the identification information of the detected base station 102-6. The communications device 101 determines whether the identification information of the base station 102-6 acquired this time matches the identification information of the base station 102-6 acquired last time. In this example, the identification information of the base station 102-6 matches the identification information of the base station 102-6 acquired last time.

Therefore, the communications device 101 determines that the identification information of the base station 102-6 acquired this time matches the identification information of the base station 102-6 acquired last time, and sets the given interval T to the interval T2. In other words, the communications device 101 decides that the user is not moving, and sets the given interval T to the interval T2, which is longer than the interval T1 set if the user is moving.

In an example indicated by 3 in FIG. 1, the user of the communications device 101 is going to the train station after the end of work at the company and moves from the communication area A6 of the base station 102-6 to the communication area A4 of the base station 102-4. It is assumed that the base station 102-4 is detected after the given interval T has elapsed from the detection of the base station 102-6.

In this case, the communications device 101 acquires the identification information of the detected base station 102-4. The communications device 101 determines whether the identification information of the base station 102-4 acquired this time matches the identification information of the base station 102-6 acquired last time. In this example, the identification information of the base station 102-4 does not match the identification information of the base station 102-6.

Therefore, the communications device 101 determines that the identification information of the base station 102-4 acquired this time does not match the identification information of the base station 102-6 acquired last time, and sets the given interval T to the interval T1. In other words, the communications device 101 decides that the user is moving, and sets the given interval T to the interval T1 shorter than the interval T2 set if the user is not moving.

As described above, the communications device 101 according to the first embodiment can acquire the identification information of the base station 102 detected at the given interval T and can determine whether the identification information of the base station 102 acquired this time matches the identification information of the base station 102 acquired last time. As a result, whether the user of the communications device 101 is moving can be determined.

If the identification information of the base station 102 acquired this time matches the identification information of the base station 102 acquired last time, the communications device 101 can set the given interval T to the interval T2, which is longer than the interval T1. As a result, if the user is not moving, the number of times the scanning operation is performed can be reduced to suppress the power consumption of the communications device 101 as compared to when the user is moving.

If the identification information of the base station 102 acquired this time does not match the identification information of the base station 102 acquired last time, the communications device 101 can set the given interval T to the interval T1, which is shorter than the interval T2. As a result, if the user is moving, the scanning operation can be performed with a shorter interval to increase the re-connectivity to the available base station 102 as compared to when the user is not moving.

A system configuration example of a communication system 200 according to the first embodiment will be described. In the following description, an access point of a wireless LAN will be taken as an example of the base station 102 depicted in FIG. 1.

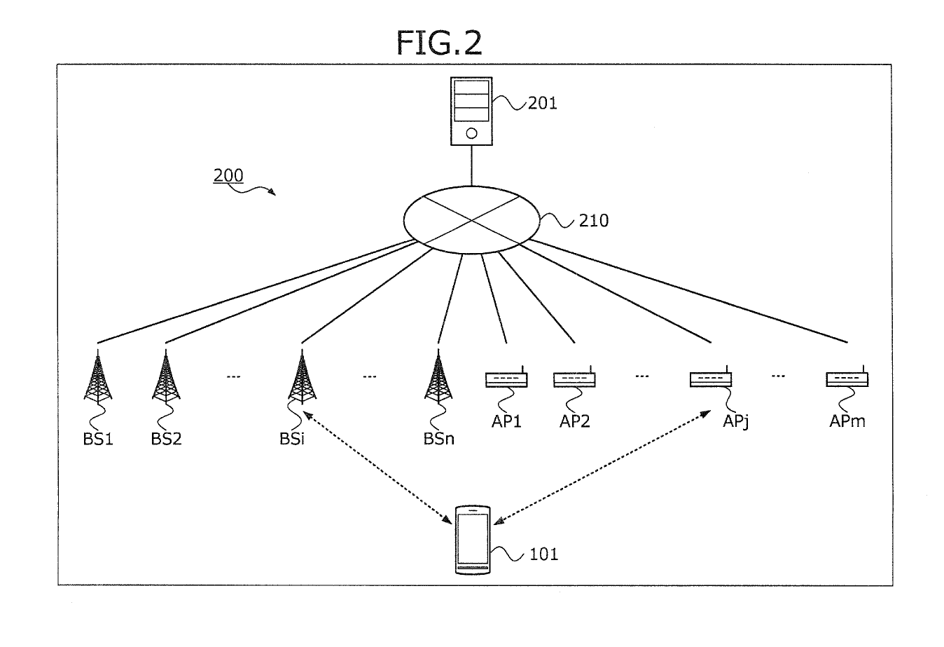

FIG. 2 is an explanatory diagram of a system configuration example of the communication system 200. In FIG. 2, the communication system 200 includes the communications device 101, base stations BS1 to BSn, access points AP1 to APm, and a server 201. In the communication system 200, the base stations BS1 to BSn, the access points AP1 to APm, and the server 201 are connected via a network 210. The network 210 includes a mobile communications network, a LAN, a WAN, and the Internet, for example.

The base stations BS1 to BSn are base stations of a mobile communications network scattered at various locations. The access points AP1 to APm are base stations of a wireless LAN scattered at various locations. The access points AP1 to APm may include a portable access point or an access point disposed in a mobile body such as a train and a bus. For example, an access point APj tends to have faster maximum communication speed and higher transmission efficiency with a narrower communicable range as compared to a base station BSi.

In the following description, an arbitrary base station of the base stations BS1 to BSn may be referred to as the “base station BSi”, and a communication area representative of a communicable range of the base station BSi may be referred to as a “cell Ci” (i=1, 2, . . . , n). An arbitrary access point of the access points AP1 to APm may be referred to as the “access point APj”, and a communication area representative of a communicable range of the access point APj may be referred to as a “communication area Aj” (j=1, 2, . . . , m).

The communications device 101 detects the base station BSi and the access point APj by respectively different detection operations. The communications device 101 can wirelessly communicate with the detected base station BSi to connect to the network 210, via the base station BSi. The communications device 101 can also wirelessly communicate with the detected access point APj to connect to the network 210, via the access point APj.

The server 201 is a computer providing a service via the network 210 to the communications device 101. The service is an information process provided to the communications device 101 and includes a mail service, a telephone service, and a web service, for example. For instance, the server 201 includes a mail server, a web server, an application server, and a database server.

Although only one communications device 101 and one server 201 are depicted in FIG. 2, this is not a limitation. For example, the communications devices 101 may be disposed for respective users utilizing the communication system 200, and the servers 201 may be disposed for respective providers of services.

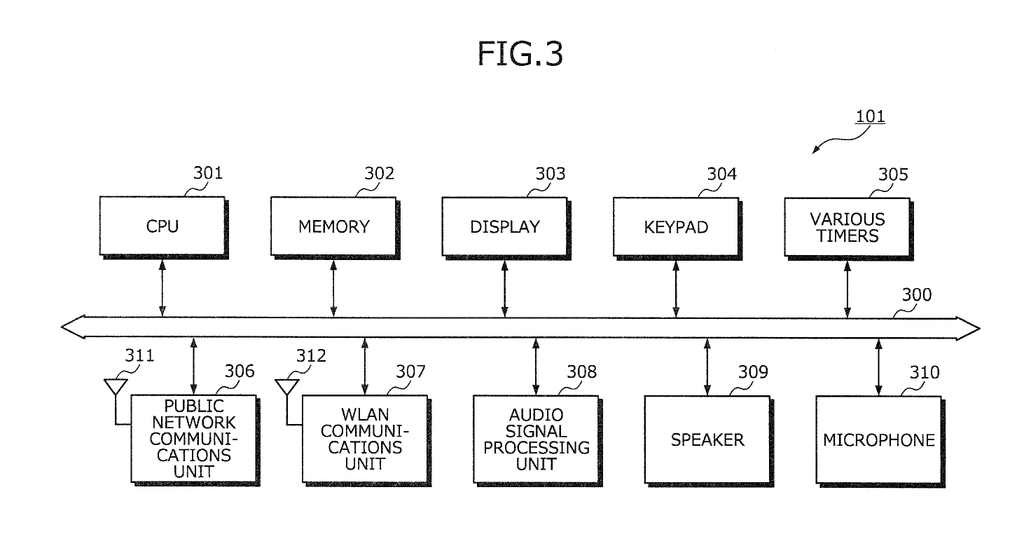

A hardware configuration example of the communications device 101 will be described. FIG. 3 is a block diagram of a hardware configuration example of the communications device 101. In FIG. 3, the communications device 101 has a CPU 30, memory 302, a display 303, a keypad 304, various timers 305, a public network communications unit 306, a wireless LAN (WLAN) communications unit 307, an audio signal processing unit 308, a speaker 309, and a microphone 310. The constituent units are connected to each other through a bus 300.

The CPU 301 governs overall control of the communications device 101. The memory 302 includes, for example, read-only memory (ROM), random access memory (RAM) and flash ROM. More specifically, for example, the flash ROM stores an operating system (OS) program; the ROM stores application programs; and the RAM is used as a work area of the CPU 301. The programs stored in the memory 302 are loaded to the CPU 301, whereby encoded processes are executed by the CPU 301.

The display 303 displays data such as text, images and functional information in addition to a cursor, icons, and toolboxes. A liquid crystal display, an electroluminescence display, and the like may be adopted as the display 303.

The keypad 304 has keys for inputting text, numerals, various instructions, etc. and performs the input of data. The keypad 304 may be, for example, a touch panel input pad, a ten-key, and the like. The various timers 305 measure time.

The public network communications unit 306 uses an antenna 311 to wirelessly transmit signals and receive wirelessly transmitted signals. For example, the public network communications unit 306 is connected to the network 210, via the base station BSi of the mobile communications network and is connected to another computer (e.g., the server 201), via the network 210. The public network communications unit 306 is responsible for an internal interface with the network 210 and controls the input and output of data with respect to the other computer. The public network communications unit 306 includes a public network interface (I/F), an arithmetic circuit, a transmission/reception circuit, and memory, for example.

The WLAN communications unit 307 uses an antenna 312 to wirelessly transmit signals and receive wirelessly transmitted signals. For example, the WLAN communications unit 307 is connected to the network 210, via the access point APj of the wireless LAN, and is connected to another computer, via the network 210. The WLAN communications unit 307 is responsible for an internal interface with the network 210 and controls the input and output of data with respect to the other computer. The WLAN communications unit 307 includes a WLAN I/F, an arithmetic circuit, a transmission/reception circuit, and a memory, for example.

The audio signal processing unit 308 is connected to the speaker 309 and the microphone 310. For example, sound received by the microphone 310 is A/D-converted by the audio signal processing unit 308. Sound is output from the speaker 309.

Although not depicted, the communications device 101 has, for example, a memory controller that controls the reading and writing of data with respect to the memory 302, a power management unit (PMU) that supplies power-supply voltage to the constituent units, a battery, and a global positioning system (GPS) unit, in addition to the constituent units described above. The hardware configurations of the base station BSi, the access point APj, and the server 201 are implemented by a CPU, memory, an I/F, an auxiliary storage device, and a bus, for example.

A connection recording table 400 used by the communications device 101 will be described. The connection recording table 400 is implemented by using the memory 302 depicted in FIG. 3 and memory of the WLAN communications unit 307, for example.

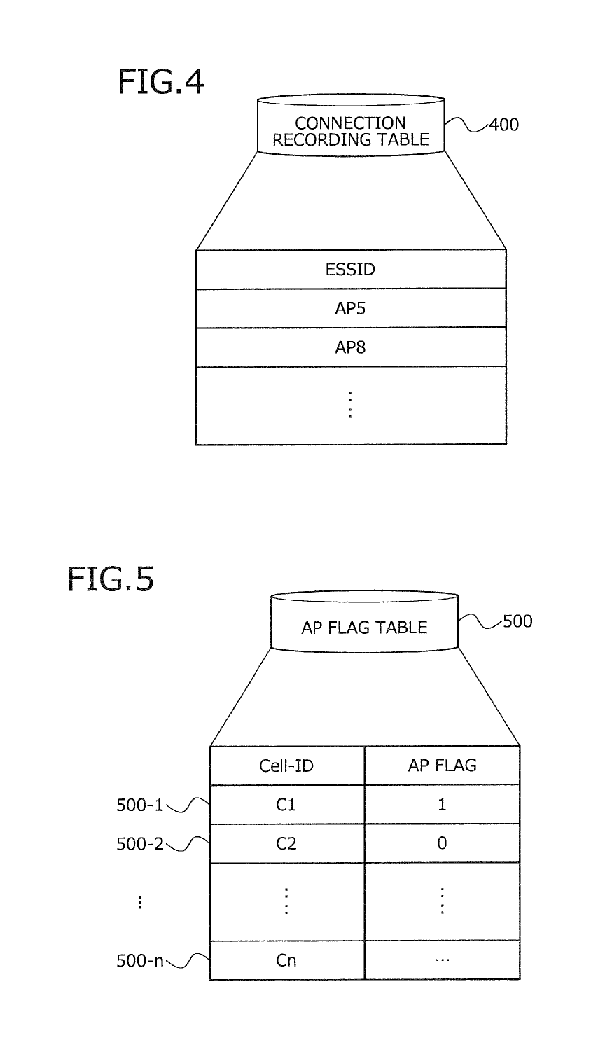

FIG. 4 is an explanatory diagram of an example of the contents stored by the connection recording table 400. In FIG. 4, the connection recording table 400 stores the extended service set identifiers (ESSIDs) of the access points APj to which the communications device 101 connected.

An ESSID is identification information for uniquely identifying an access point APj. A basic SSID (BSSID) may be used as the identification information of the access point APj. A record of connection represents a history of proper completion of a process to connect to the access point APj by the communications device 101.

In the example depicted in FIG. 4, the table indicates the ESSIDs “AP5, AP8” of the access points AP5, AP8 to which the communications device 101 connected.

An AP flag table 500 used by the communications device 101 will be described. The AP flag table 500 is implemented by using the memory 302 depicted in FIG. 3 and memory of the WLAN communications unit 307, for example.

FIG. 5 is an explanatory diagram of an example of the contents stored by the AP flag table 500. In FIG. 5, the AP flag table 500 has fields of cell-IDs and AP flags. By setting information in the fields, AP flag information 500-1 to 500-n is stored as records.

The cell-ID is identification information identifying a base station BSi. In this example, the identification information of the cell Ci is used as the identification information of the base station BSi. The AP flag is a flag indicative of the presence/absence of the access point APj present in the cell Ci of the base station BSi. An AP flag of “1” indicates that the access point APj is present in the cell Ci, while the AP flag of “0” indicates that the access point APj is not present in the cell Ci.

By way of example, in the case of the AP flag information 500-1, the cell-ID “C1” is correlated with the AP flag “1”. According to the AP flag information 500-1, it can be identified that the access point APj is present in the cell C1 of the base station BS1.

An ESSID list 600 used by the communications device 101 will be described. The ESSID list 600 is implemented by using the memory 302 depicted in FIG. 3 and memory of the WLAN communications unit 307, for example.

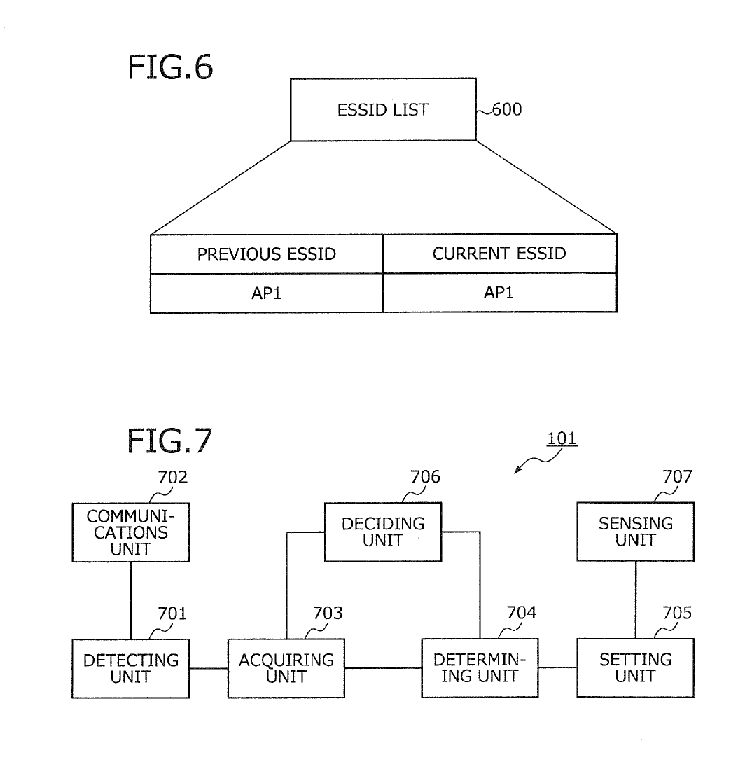

FIG. 6 is an explanatory diagram of an example of the contents of the ESSID list 600. In FIG. 6, the ESSID list 600 is a list indicative of the ESSIDs of the access points APj detected by the communications device 101. The ESSID list 600 enables the identification of the ESSID of the access point APj detected by the previous scanning operation and the ESSID of the access point APj detected by the current scanning operation.

A functional configuration example of the communications device 101 according to the first embodiment will be described. FIG. 7 is a block diagram of a functional configuration of the communications device 101. In FIG. 7, the communications device 101 has a configuration including a detecting unit 701, a communications unit 702, an acquiring unit 703, a determining unit 704, a setting unit 705, a deciding unit 706, and a sensing unit 707. The detecting unit 701 to the sensing unit 707 are functions acting as a control unit and, for example, are implemented by causing the CPU 301 to execute a program stored in the memory 302 depicted in FIG. 3, or by the WLAN communications unit 307. The functions may be implemented by causing the arithmetic circuit of the WLAN communications unit 307 to execute a program stored in the memory of the WLAN communications unit 307, or by the WLAN I/F of the WLAN communications unit 307. Processing results of the functional units are stored in the memory 302 and the memory of the WLAN communications unit 307, for example.

The detecting unit 701 has a function of detecting the wirelessly communicating access point APj at the given interval T. For example, the detecting unit 701 controls the communications unit 702 wirelessly communicating with the access point APj to perform the scanning operation (detection operation) for the access point APj.

In particular, for example, the detecting unit 701 controls the communications unit 702 to transmit a probe request signal to each channel (CH) used in the wireless LAN. As a result, the communications unit 702 receives a probe response signal including an ESSID, which enables the detecting unit 701 to detect the communicable access point APj.

The given interval T can be set arbitrarily and is stored in the memory 302 and the memory of the WLAN communications unit 307, for example. For example, the given interval T is initialized to a reference interval T₀ (e.g., 5 [minutes]). The start timing of performing the scanning operation for the access point APj at the given interval T is controlled by the various timers 305 depicted in FIG. 3, for example.

The acquiring unit 703 has a function of acquiring the identification information of the access point APj detected by the detecting unit 701. For example, if the access point APj is detected, the acquiring unit 703 acquires the ESSID included in the probe response signal from the access point APj.

The communications device 101 may be communicable with multiple access points among the access points AP1 to APm. In this case, the detecting unit 701 detects multiple access points. The acquiring unit 703 acquires the respective ESSIDs of the detected multiple access points.

The acquired ESSID of the access point APj is stored in the ESSID list 600 depicted in FIG. 6, for example. For example, if the ESSID is acquired, the acquiring unit 703 overwrites the previous ESSID field with the ESSID set in the current ESSID field of the ESSID list 600 and overwrites the current ESSID field with the acquired ESSID.

The determining unit 704 has a function of determining whether the identification information of the access point APj acquired by the acquiring unit 703 matches the identification information of the access point APj acquired last time by the acquiring unit 703. For example, the determining unit 704 refers to the ESSID list 600 to determine whether the ESSID set in the current ESSID field matches the ESSID set in the previous ESSID field.

If multiple ESSIDs are set in the current ESSID field, the determining unit 704 determines whether at least any one of the current multiple ESSIDs matches the ESSID set in the previous ESSID field. If multiple ESSIDs are set in the previous ESSID field, the determining unit 704 determines whether the ESSID set in the current ESSID field matches at least any one of the previous multiple ESSIDs.

If no ESSID is set in the current ESSID field while an ESSID is set in the previous ESSID field, the determining unit 704 may determine that the current ESSID does not match the previous ESSID. If an ESSID is set in the current ESSID field while no ESSID is set in the previous ESSID field, the determining unit 704 may determine that the current ESSID does not match the previous ESSID.

In the following description, a “determination process” may refer to a process of the determining unit 704 determining whether the ESSID of the access point APj acquired this time by the acquiring unit 703 matches the ESSID of the access point APj acquired last time by the acquiring unit 703.

The setting unit 705 has a function of changing the given interval T based on a determination result obtained by the determining unit 704. For example, if it is determined that the current ESSID matches the previous ESSID, the setting unit 705 sets the given interval T to the interval T2. The interval T2 is an interval longer than the interval T1 set if it is determined that the current ESSID does not match the previous ESSID. The interval T2 may be an interval longer than the reference interval T₀, for example. The interval T2 is about 10 to 30 [minutes], for example.

If the current ESSID matches the previous ESSID, it can be determined that the user of the communications device 101 has not moved to another place after the scanning operation of the previous period. In this case, the given interval T can be set to the interval T2 to perform the scanning operation for the access point APj using a longer interval as compared to when the user has moved.

For example, if it is determined that the current ESSID does not match the previous ESSID, the setting unit 705 sets the given interval T to the interval T1. The interval T1 is an interval shorter than the interval T2 and may be an interval shorter than the reference interval T₀, for example. The interval T1 is about 1 to 3 [minutes], for example.

If the current ESSID does not match the previous ESSID, it can be determined that the user of the communications device 101 has moved to another location after the scanning operation of the previous period. In this case, the given interval T can be set to the interval T1 to perform the scanning operation for the access point APj using a shorter interval as compared to when the user has not moved.

The deciding unit 706 has a function of deciding whether a record of connection exists for the execution of a connection process of connecting to the network via the access point APj detected by the detecting unit 701. For example, the deciding unit 706 refers to the connection recording table 400 depicted in FIG. 4 to decide whether the ESSID of the detected access point APj is registered. If the ESSID is registered, the deciding unit 706 decides that a record of connection to the access point APj exists. On the other hand, if the ESSID is not registered, the deciding unit 706 decides that a record of connection to the access point APj does not exist.

The determining unit 704 may execute the determination process if the deciding unit 706 decides that no record of connection to the access point APj exists. As a result, the communications device 101 can execute the sequence of changing the given interval T of the scanning operation if the detected access point APj is unavailable.

If it is decided that a record of connection to the access point APj exists, the communications device 101 may start the connection process to the access point APj. In other words, if a record of connection to the access point APj exists, the communications device 101 decides that the access point APj is available, and executes the connection process to the access point APj.

The communications device 101 may start the connection process to the access point APj according to operational input from the user using the keypad 304 depicted in FIG. 3. For example, when connecting to the access point APj for the first time, the communications device 101 starts the connection process to the detected access point APj according to the operational input from the user.

When connecting to the access point APj for the first time, if the connection process to the access point APj is completed properly, the communications device 101 may newly register the ESSID of the access point APj of the connection to the connection recording table 400, for example. As a result, the contents stored by the connection recording table 400 can be updated according to the record of connection of the communications device 101 to the access point APj.

The sensing unit 707 has a function of sensing a transition of the display state of the display 303 (see FIG. 3) from displaying to non-displaying. The display state of non-displaying (screen-OFF) is the state in which power supply to the display 303 is stopped, for example. The display state of displaying (screen-ON) is the state in which power supply to the display 303 is performed, for example.

For example, if the display state of the display 303 is switched from non-displaying to displaying by operational input from the user using the keypad 304, the sensing unit 707 senses the transition of the display state of the display 303 from non-displaying to displaying. In particular, for example, if a resume function is activated to resume operation from the state immediately before screen-OFF, the sensing unit 707 may sense the transition of the display state of the display 303 from non-displaying to displaying. For example, in the case of activation of an application such as an alarm activated at predetermined time, the sensing unit 707 may sense the transition of the display state of the display 303 from non-displaying to displaying.

If the sensing unit 707 senses the transition of the display state from non-displaying to displaying, the setting unit 705 may set the given interval T to an interval T3. The interval T3 is an interval that is shorter than the interval T1. The interval T3 is about 5 to 10 [seconds], for example. As a result, the re-connectivity to the access point APj can be improved at the time of screen-ON.

The sensing unit 707 may sense the activation of software generating communication with another apparatus during execution. The software generating communication with another apparatus during execution is a so-called communication application and is, for example, a browser.

If the sensing unit 707 senses the activation of the software causing communication with another apparatus during execution, the setting unit 705 may set the given interval T to the interval T3. As a result, the re-connectivity to the access point APj can be improved when the communication application is executed.

The determining unit 704 may execute the determination process when a certain time L has elapsed after the transition of the display state of the display 303 from non-displaying to displaying. The certain time L is set to a value allowing the communications device 101 to perform the scanning operation for the access point APj multiple times using the interval T3, for example. The certain time L is about 20 to 30 [seconds], for example. The certain time L is measured by the various timers 305, for example.

As a result, the communications device 101 can execute the sequence of changing the given interval T of the scanning operation after waiting until the certain time L has elapsed from screen-ON so as to ensure the re-connectivity to the access point APj at the time of screen-ON, for example. The communications device 101 can execute the sequence of changing the given interval T of the scanning operation after waiting until the certain time L has elapsed from the start of execution of the communication application so as to ensure the re-connectivity to the access point APj at the time of execution of the communication application, for example.

The setting unit 705 may set the interval T1 at the time of screen-ON to a value (hereinafter referred to as an “interval T1′”) shorter than the interval T1 at the time of screen-OFF. As a result, the re-connectivity at the time of screen-ON can be improved as compared to the time of screen-OFF. Similarly, the setting unit 705 may set the interval T2 at the time of screen-ON to a value (hereinafter referred to as an “interval T2′”) that is shorter than the interval T2 at the time of screen-OFF. As a result, the re-connectivity at the time of screen-ON can be improved as compared to the time of screen-OFF.

When the access point APj is detected multiple times by the interval T3, if the communications device 101 cannot connect to the access point APj multiple consecutive times (e.g., three times, five times), the setting unit 705 may set the given interval T to the interval T2′ even within the certain time L. In particular, if the connection to the access point APj fails multiple consecutive times, it is unlikely that the communications device 101 can subsequently connect thereto and, therefore, the communications device 101 may change the given interval T from the interval T3 to the interval T2′ to suppress power consumption.

The deciding unit 706 may decide whether the access point APj is disposed in the cell Ci in which the communications device 101 is present, based on information identifying the cell disposed with the access point APj among the cells C1 to Cn of the base stations BS1 to BSn. For example, the deciding unit 706 refers to the AP flag table 500 depicted in FIG. 5 to decide whether the access point APj is disposed in the cell Ci in which the communications device 101 is present.

The communications device 101 can identify the cell Ci in which the communications device 101 is present by communicating with the base station BSi. For example, the communications device 101 receives base station information transmitted regularly, for example, every 2.56 [seconds] from the base station BSi. The base station information includes the cell-ID of the base station BSi.

In this case, the deciding unit 706 identifies the cell-ID included in the received base station information as the cell-ID of the cell Ci to which the communications device 101 belongs. The deciding unit 706 refers to the AP flag table 500 to decide whether “1” is set as the AP flag of the AP flag information 500-i corresponding to the identified cell-ID of the cell Ci.

If “1” is set as the AP flag, the deciding unit 706 decides that the access point APj is disposed in the cell Ci in which the communications device 101 is present. On the other hand, if “0” is set as the AP flag, the deciding unit 706 decides that the access point APj is not disposed in the cell Ci in which the communications device 101 is present.

If the access point APj is not disposed in the cell Ci in which the communications device 101 is present, the communications device 101 may set a scan flag to OFF. The scan flag is a flag indicative of whether the scanning operation for the access point APj is periodically performed. On the other hand, if the access point APj is disposed in the cell Ci in which the communications device 101 is present, the communications device 101 may set the scan flag to ON.

The scan flag is stored in the memory 302, a register of the CPU 301, and the memory of the WLAN communications unit 307, for example. A changing process of the scan flag is executed, for example, if the base station information received from the base station BSi is different from the base station information received last time, i.e., if the base station information is updated.

The communications device 101 may be communicable with multiple base stations among the base stations BS1 to BSn. In this case, for example, the deciding unit 706 may identify the cell-ID included in the base station information of the base station having the strongest radio wave strength among the communicable base stations, as the cell-ID identifying the cell Ci to which the communications device 101 belongs.

If the deciding unit 706 decides that the access point APj is disposed in the cell Ci in which the communications device 101 is present, the detecting unit 701 may start a detection process of detecting the access point APj with the given interval T. For example, if the scan flag is set to ON, the detecting unit 701 starts the detection process of detecting the access point APj with the given interval T. On the other hand, if the scan flag is set to OFF, the detecting unit 701 does not start the detection process of detecting the access point APj with the given interval T. As a result, the communications device 101 can reduce the power consumption required for the scanning operation when the access point APj is not present in the cell Ci in which the communications device 101 is present.

If the ESSID is set in neither the current ESSID field nor the previous ESSID field of the ESSID list 600, the setting unit 705 may set the given interval T to the reference interval T₀. In other words, if the ESSID of the access point APj cannot be acquired in succession, it cannot be determined whether the user is moving and therefore, the setting unit 705 sets the given interval T to the reference interval T₀.

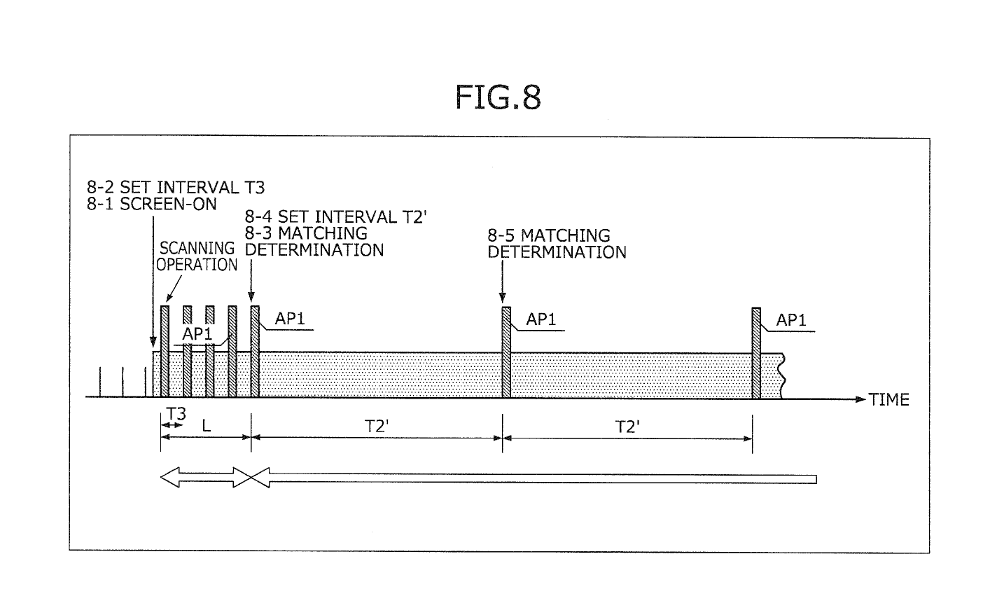

An operation example of the communications device 101 according to the first embodiment will be described with reference to FIGS. 8 to 12.

FIG. 8 is an explanatory diagram (part one) of an operation example of the communications device 101 according to the first embodiment. In FIG. 8, as indicated by ‘8-1’, the communications device 101 senses the transition of the display state of the display 303 from non-displaying to displaying. As indicated by ‘8-2’, if the transition of the display state is made from non-displaying to displaying, the communications device 101 sets the given interval T to the interval T3. As a result, the scanning operation for the access point APj is performed using the interval T3.

As indicated by ‘8-3’, the communications device 101 makes the matching determination between the current ESSID and the previous ESSID after the certain time L has elapsed. In this case, the current ESSID “AP1” matches the previous ESSID “AP1”. As indicated by ‘8-4’, if the current ESSID matches the previous ESSID, the communications device 101 sets the given interval T to the interval T2′. As a result, the scanning operation for the access point APj is performed using the interval T2′.

As indicated by ‘8-5’, the communications device 101 makes the matching determination between the current ESSID and the previous ESSID after the interval T2′ has elapsed. In this case, the current ESSID “AP1” matches the previous ESSID “AP1”. In this case, the given interval T is not changed from the interval T2′. Therefore, the scanning operation for the access point APj is subsequently performed using the interval T2′.

As described above, the communications device 101 can perform the scanning operation using the interval T3 (e.g., 10 [seconds]) immediately after screen-ON. As a result, the re-connectivity to the access point APj can be improved immediately after screen-ON. Even if the connection cannot be established by one scanning operation, the communications device 101 can perform the scanning operation multiple times using the interval T3 from screen-ON until the certain time L has elapsed and therefore, the re-connectivity to the access point APj can be improved.

The communications device 101 can make the matching determination between the current ESSID and the previous ESSID after the certain time L has elapsed since the setting of the interval T3. As a result, if the communications device 101 is not connected to the access point APj even if the certain time L has elapsed since screen-ON when the user is not moving, the given interval T can be changed to the interval T2′ (e.g., 5 [minutes]) to suppress the power consumption required for the scanning operation.

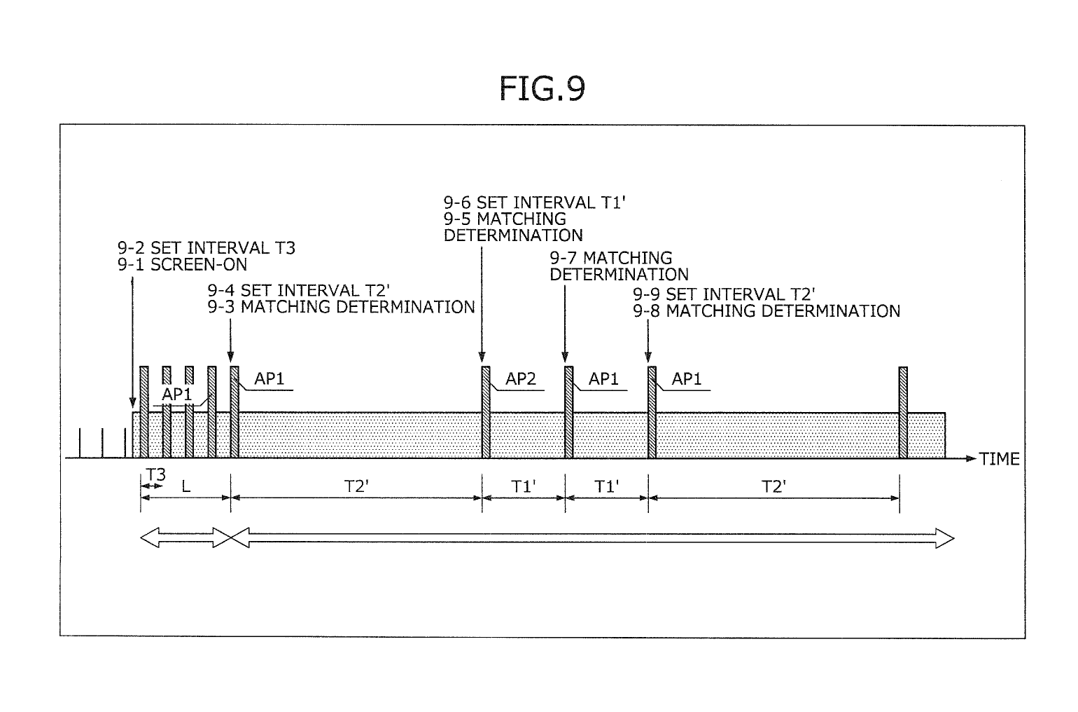

FIG. 9 is an explanatory diagram (part two) of an operation example of the communications device 101 according to the first embodiment. The operations indicated by ‘9-1’ to ‘9-4’ depicted in FIG. 9 are the same as the operations indicated by ‘8-1’ to ‘8-4’ depicted in FIG. 8 and therefore, will not be described.

In FIG. 9, as indicated by ‘9-5’, the communications device 101 makes the matching determination between the current ESSID and the previous ESSID after the interval T2′ has elapsed. In this case, the current ESSID “AP2” does not match the previous ESSID “AP1”. As indicated by ‘9-6’, if the current ESSID does not match the previous ESSID, the communications device 101 sets the given interval T to the interval T1′. As a result, the scanning operation for the access point APj is performed with the interval T1′.

As indicated by ‘9-7’, the communications device 101 makes the matching determination between the current ESSID and the previous ESSID after the interval T1′ has elapsed. In this case, the current ESSID “AP1” does not match the previous ESSID “AP1”. In this case, the given interval T is not changed from the interval T1′. Therefore, the scanning operation for the access point APj is subsequently performed using the interval T1′.

As indicated by ‘9-8’, the communications device 101 makes the matching determination between the current ESSID and the previous ESSID after the interval T1′ has elapsed. In this case, the current ESSID “AP1” matches the previous ESSID “AP1”. As indicated by ‘9-9’, if the current ESSID matches the previous ESSID, the communications device 101 sets the given interval T to the interval T2′. As a result, the scanning operation for the access point APj is performed using the interval T2′.

As described above, if the user starts moving after the given interval T is set to the interval T2′ (e.g., 5 [minutes]), the communications device 101 can change the given interval T to the interval T1′ (e.g., 1 [minute]) to improve the re-connectivity to the access point APj.

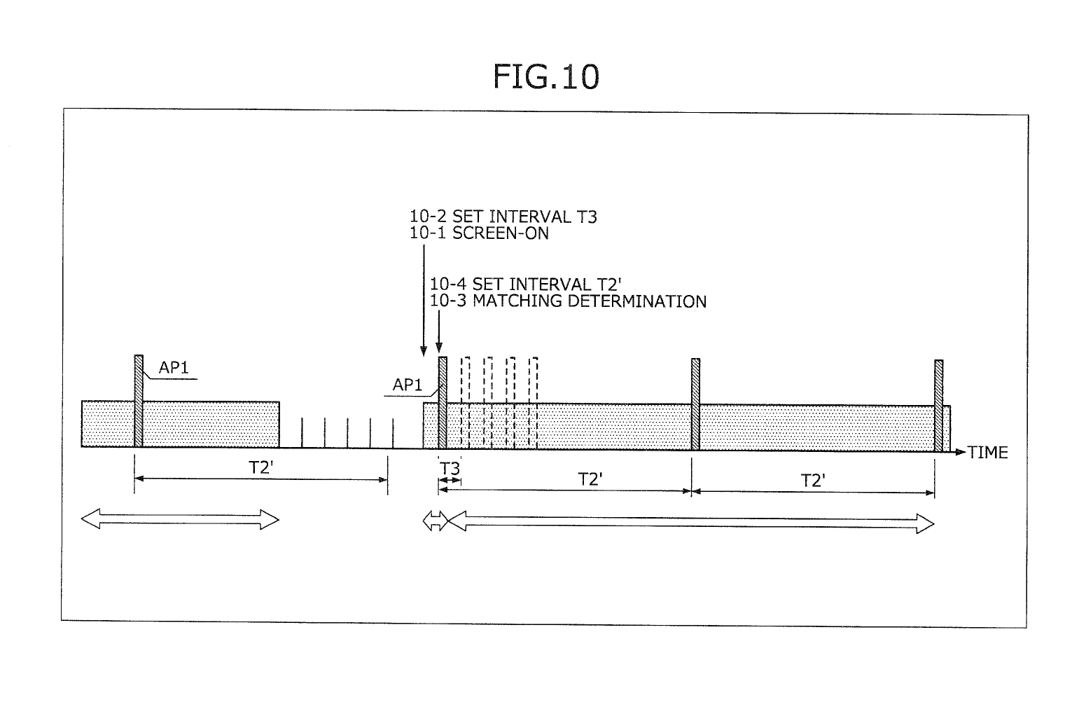

FIG. 10 is an explanatory diagram (part three) of an operation example of the communications device 101 according to the first embodiment. The operation example of the communications device 101 depicted in FIG. 10 is an operation example of screen-OFF after the predetermined time T is set to the interval T2 at the time of screen-ON.

In FIG. 10, as indicated by ‘10-1’, the communications device 101 senses the transition of the display state of the display 303 from non-displaying to displaying. As indicated by ‘10-2’, if the transition of the display state of the display 303 is made from non-displaying to displaying, the communications device 101 sets the given interval T to the interval T3. As a result, the scanning operation for the access point APj is performed using the interval T3.

As indicated by ‘10-3’, as a result of detection of the access point APj, the communications device 101 makes the matching determination between the current ESSID and the previous ESSID. In this case, the current ESSID “AP1” matches the previous ESSID “AP1”. As indicated by ‘10-4’, if the current ESSID matches the previous ESSID, the communications device 101 sets the given interval T to the interval T2′. As a result, the scanning operation for the access point APj is performed using the interval T2′.

As described above, after the given interval T is set to the interval T3 (e.g., 5 [seconds]) at the time of screen-ON, if the access point is the same as that immediately before screen-ON is detected, the communications device 101 can change the given interval T to the interval T2′ (e.g., 5 [minutes]) even before the certain time L has elapsed. As a result, the power consumption required for the scanning operation for the access point APj can be suppressed.

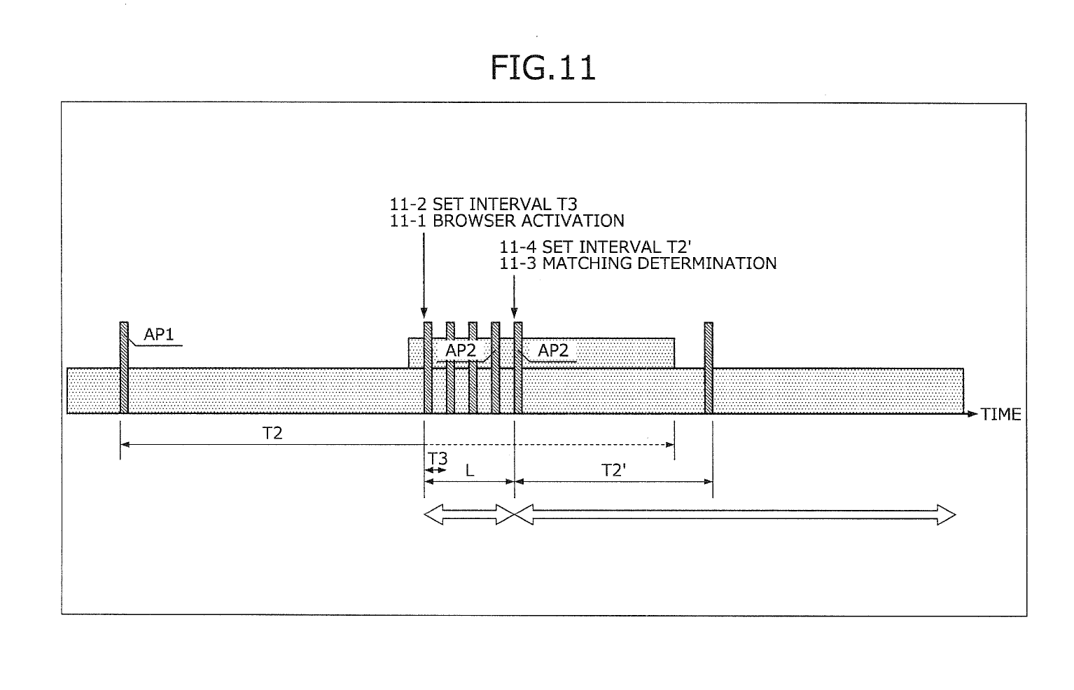

FIG. 11 is an explanatory diagram (part four) of an operation example of the communications device 101 according to the first embodiment. The operation example of the communications device 101 depicted in FIG. 11 is an operation example when the communication application (e.g., a browser) is activated.

In FIG. 11, as indicated by ‘11-1’, the communications device 101 detects the activation of the browser. As indicated by ‘10-2’, if the browser is activated, the communications device 101 sets the given interval T to the interval T3. As a result, the scanning operation for the access point APj is performed using the interval T3.

As indicated by ‘11-3’, the communications device 101 makes the matching determination between the current ESSID and the previous ESSID after the certain time L has elapsed. In this case, the current ESSID “AP2” matches the previous ESSID “AP2”. As indicated by ‘11-4’, if the current ESSID matches the previous ESSID, the communications device 101 sets the given interval T to the interval T2′. As a result, the scanning operation for the access point APj is performed using the interval T2′.

As described above, the communications device 101 can perform the scanning operation using the interval T3 (e.g., 5 [seconds]) immediately after the activation of the browser. As a result, the re-connectivity to the access point APj can be improved immediately after the activation of the browser.

The communications device 101 can make the matching determination between the current ESSID and the previous ESSID after the certain time L has elapsed from the setting of the interval T3. As a result, if the communications device 101 is not connected to the access point APj even when the certain time L has elapsed from screen-ON while the user is not moving, the given interval T can be changed to the interval T2′ (e.g., 5 [minutes]) to suppress the power consumption consumed for the scanning operation.

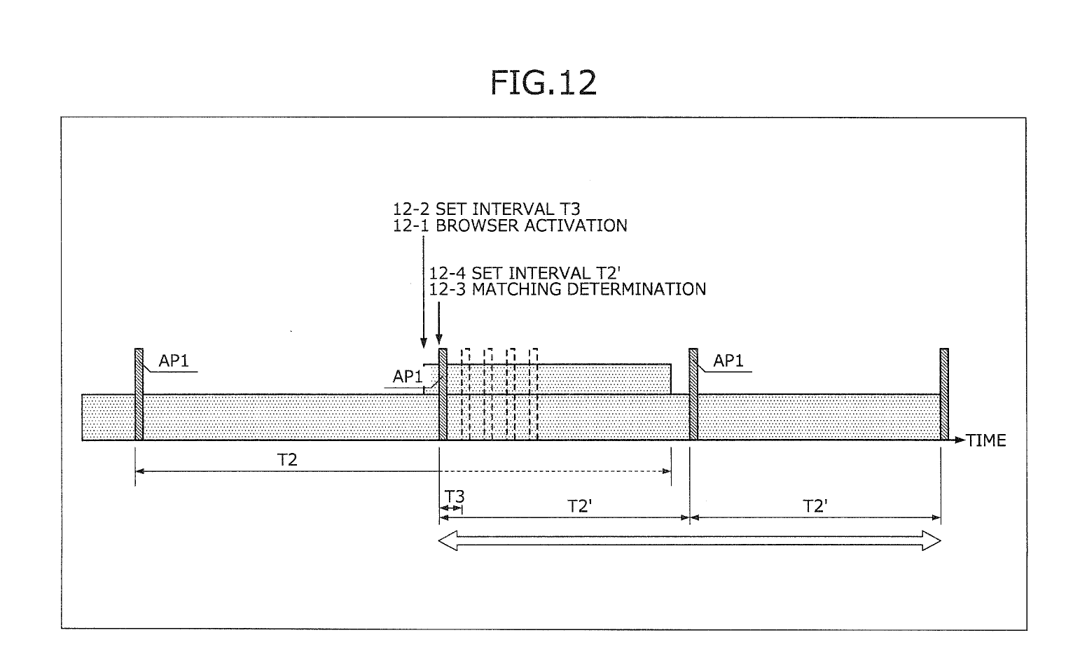

FIG. 12 is an explanatory diagram (part five) of an operation example of the communications device 101 according to the first embodiment.

In FIG. 12, as indicated by ‘12-1’, the communications device 101 detects the activation of the browser. As indicated by ‘12-2’, if the browser is activated, the communications device 101 sets the given interval T to the interval T3. As a result, the scanning operation for the access point APj is performed using the interval T3.

As indicated by ‘12-’3, the communications device 101 makes the matching determination between the current ESSID and the previous ESSID as a result of the detection of the access point APj. In this case, the current ESSID “AP1” matches the previous ESSID “AP1”. As indicated by ‘12-4’, if the current ESSID matches the previous ESSID, the communications device 101 sets the given interval T to the interval T2′. As a result, the scanning operation for the access point APj is performed using the interval T2′.

As described above, after the given interval T is set to the interval T3 (e.g., 5 [seconds]) at the time of activation of the browser, if the same access point as that immediately before activation of the browser is detected, the communications device 101 can change the given interval T to the interval T2′ (e.g., 5 [minutes]) even before the certain time L has elapsed. As a result, the power consumption consumed for the scanning operation for the access point APj can be suppressed.

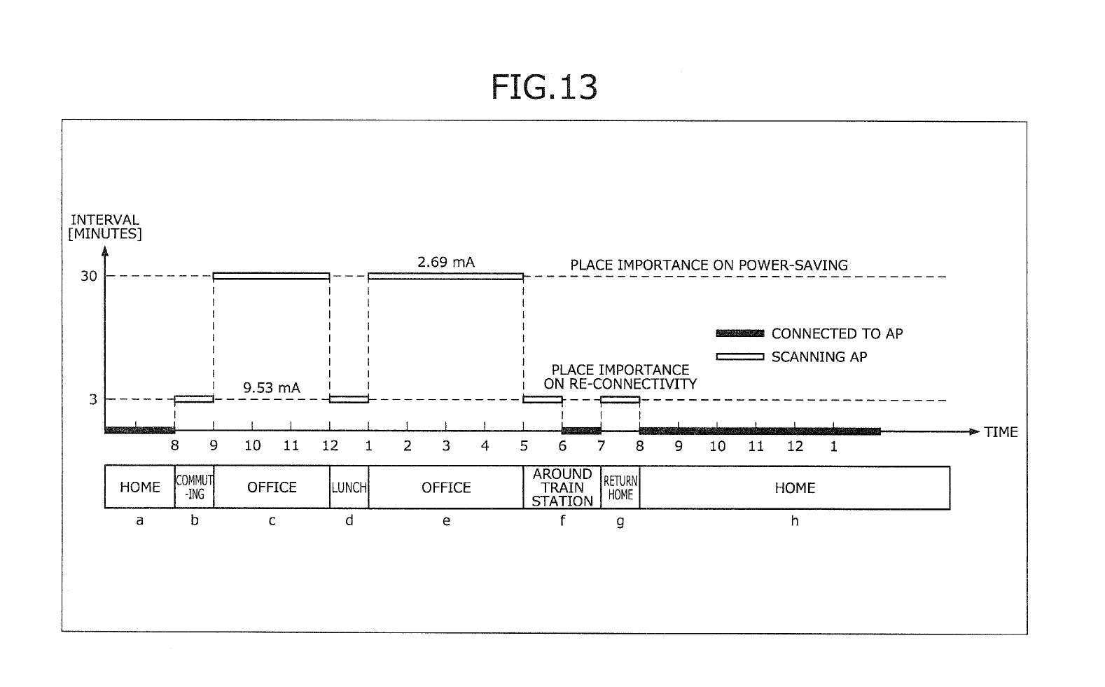

FIG. 13 is an explanatory diagram of a change example of the given interval T. In FIG. 13, as indicated by ‘a’, while the user of the communications device 101 is at home, the communications device 101 is connected to an access point disposed at home and therefore, the scanning operation for the access point APj is not performed.

As indicated by ‘b’, since the user of the communications device 101 is moving on the way to the office, the given interval T of the scanning operation is set to the interval T1 (in this example, T1=3 [minutes]) to place importance on the re-connectivity to the access point APj. In this case, the current value is 9.53 [mA] in the standby state of the communications device 101.

As indicated by ‘c’, since the user of the communications device 101 is not moving while working in the office, the given interval T of the scanning operation is set to the interval T2 (in this example, T2=30 [minutes]) to place importance on power saving. In this case, the current value is 2.96 [mA] in the standby state of the communications device 101 and the power consumption is reduced as compared to when the given interval T is the interval T1.

As indicated by ‘d’, since the user of the communications device 101 is moving to have lunch outside the office during lunch break, the given interval T of the scanning operation is set to the interval T1 to place importance on the re-connectivity to the access point APj. As indicated by ‘e’, since the user of the communications device 101 is not moving while working in the office after lunch break, the given interval T of the scanning operation is set to the interval T2 to place importance on power saving.

As indicated by ‘f’, since the user of the communications device 101 is moving to the nearest train station after the end of work at the office, the given interval T of the scanning operation is set to the interval T1 to place importance on the re-connectivity to the access point APj. When the user comes close to the train station, the communications device 101 is connected to an access point disposed in the train station, and the scanning operation for the access point APj is not performed.

As indicated by ‘g’, since the user of the communications device 101 is moving on the way to home from the train station, the given interval T of the scanning operation is set to the interval T1 to place importance on the re-connectivity to the access point APj. As indicated by ‘h’, while the user of the communications device 101 is at home after returning home, the communications device 101 is connected to the access point disposed at home and therefore, the scanning operation for the access point APj is not performed.

As described above, if the communications device 101 is not connected to the access point APj and the user is not moving, the communications device 101 can set the given interval T to the interval T2 longer than the interval T1 to place importance on the power saving. If the communications device 101 is not connected to the access point APj and the user is moving, the communications device 101 can set the given interval T to the interval T1, which is shorter than the interval T2, to place importance on the re-connectivity to the access point APj.

Various process procedures of the communications device 101 according to the first embodiment will be described. First, a communication control process (hereinafter referred to as a “first communication control process”) of the communications device 101 executed in the standby state (at the time of screen-OFF) will be described.

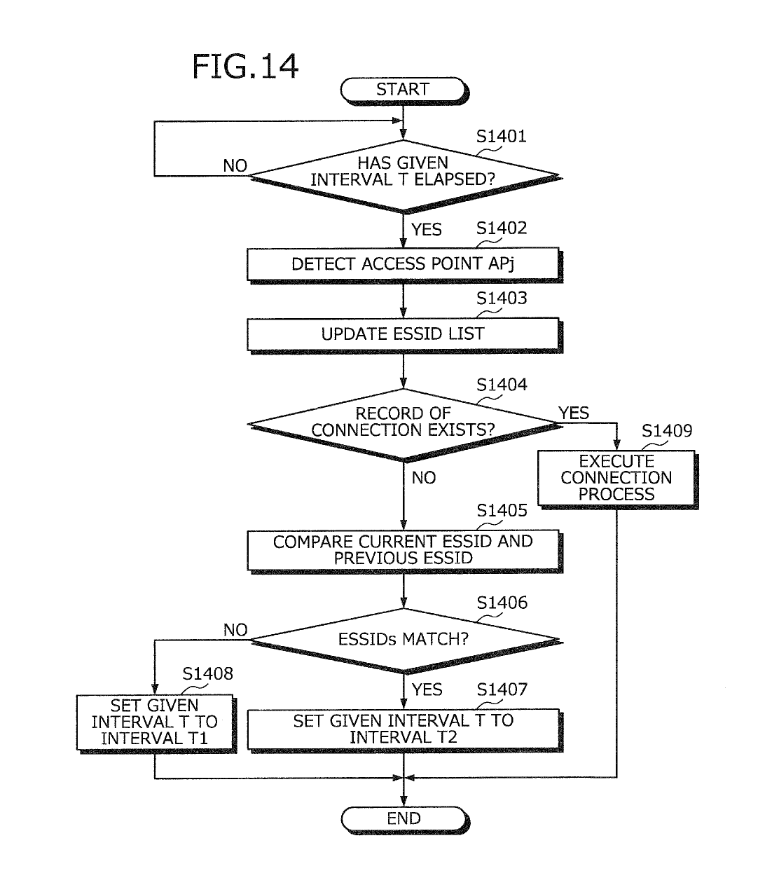

FIG. 14 is a flowchart of an example of a first communication control process procedure of the communications device 101 according to the first embodiment. In the flowchart of FIG. 14, first, the communications device 101 decides whether the given interval T of the scanning operation has elapsed (step S1401).

The communications device 101 waits until the given interval T of the scanning operation has elapsed (step S1401: NO). If the given interval T of the scanning operation has elapsed (step S1401: YES), the communications device 101 detects the access point APj (step S1402).

The communications device 101 acquires the ESSID of the detected access point APj and updates the storage contents of the ESSID list 600 (step S1403). If the access point APj is not detected, the communications device 101 leaves the current ESSID field blank (without setting).

The communications device 101 refers to the connection recording table 400 to decide whether a record of connection to the detected access point APj exists (step S1404). If no record of connection to the access point APj exists (step S1404: NO), the communications device 101 refers to the ESSID list 600 to compare the current ESSID with the previous ESSID (step S1405).

The communications device 101 decides whether the current ESSID matches the previous ESSID (step S1406). If the current ESSID matches the previous ESSID (step S1406: YES), the communications device 101 sets the given interval T of the scanning operation to the interval T2 (step S1407) and terminates a series of processes of the flowchart.

On the other hand, if the current ESSID does not match the previous ESSID (step S1406: NO), the communications device 101 sets the given interval T of the scanning operation to the interval T1 (step S1408) and terminates a series of processes of the flowchart.

If a record of connection to the access point APj exists at step S1404 (step S1404: YES), the communications device 101 executes the connection process of connecting to the network, via the access point APj (step S1409) and terminates a series of processes of the flowchart.

If the access points APj is not detected at step S1402, the communications device 101 decides that no record of connection to the access point APj exists and goes to step S1405.

As a result, if the current ESSID matches the previous ESSID, the given interval T can be set to the interval T2. If the current ESSID does not match the previous ESSID, the given interval T can be set to the interval T1.

A communication control process (hereinafter referred to as a “second communication control process”) of the communications device 101 executed at the time of screen-ON will be described.

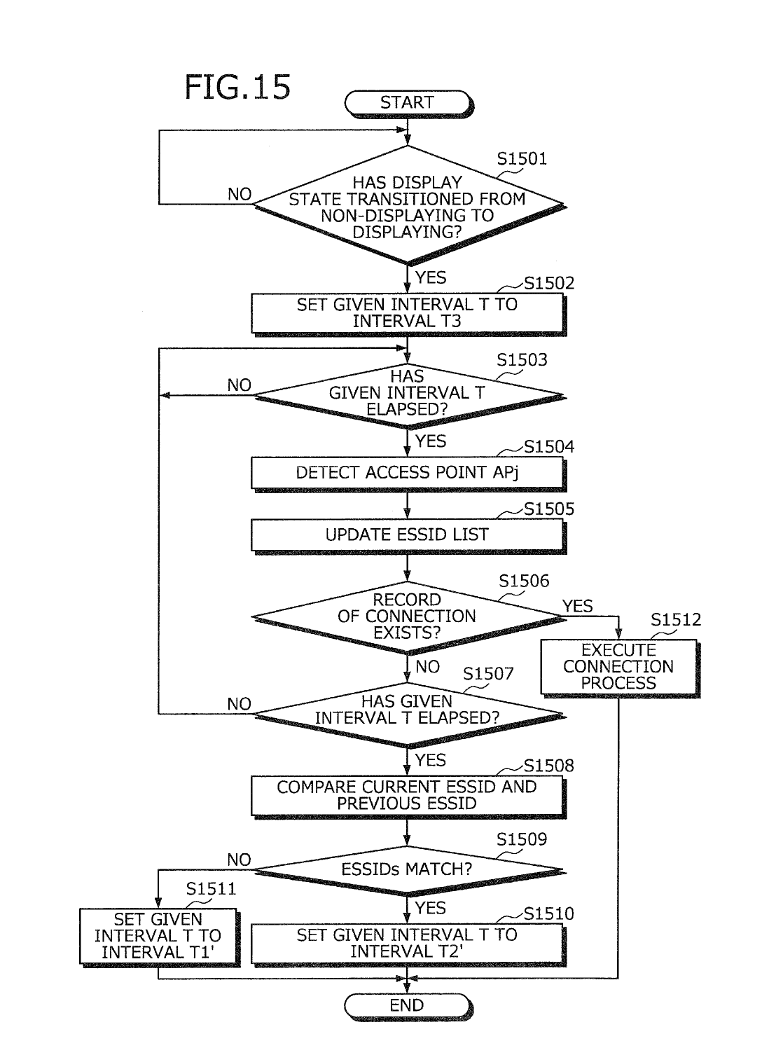

FIG. 15 is a flowchart of an example of a second communication control process procedure of the communications device 101 according to the first embodiment. In the flowchart of FIG. 15, first, the communications device 101 determines whether the display state of the display 303 has transition from non-displaying to displaying (step S1501).

The communications device 101 waits until the display state of the display 303 transitions from non-displaying to displaying (step S1501: NO). If the display state of the display 303 has transitioned from non-displaying to displaying (step S1501: YES), the communications device 101 sets the given interval T of the scanning operation to the interval T3 (step S1502).

The communications device 101 determines whether the given interval T of the scanning operation has elapsed (step S1503). The communications device 101 waits until the given interval T of the scanning operation has elapsed (step S1503: NO). If the given interval T of the scanning operation has elapsed (step S1503: YES), the communications device 101 detects the access point APj (step S1504).

The communications device 101 acquires the ESSID of the detected access point APj and updates the storage contents of the ESSID list 600 (step S1505). The communications device 101 refers to the connection recording table 400 to decide whether a record of connection to the detected access point APj exists (step S1506).

If no record of connection to the access point APj exists (step S1506: NO), the communications device 101 determines whether the certain time L has elapsed after the display state of the display 303 has transitioned from non-displaying to displaying (step S1507). If the certain time L has not elapsed (step S1507: NO), the communications device 101 returns to step S1503.

On the other hand, if the certain time L has elapsed (step S1507: YES), the communications device 101 refers to the ESSID list 600 to compare the current ESSID with the previous ESSID (step S1508). The communications device 101 determines whether the current ESSID matches the previous ESSID (step S1509).

If the current ESSID matches the previous ESSID (step S1509: YES), the communications device 101 sets the given interval T of the scanning operation to the interval T2′ (step S1510) and terminates a series of processes of the flowchart.

On the other hand, if the current ESSID does not match the previous ESSID (step S1509: NO), the communications device 101 sets the given interval T of the scanning operation to the interval T1′ (step S1511) and terminates a series of processes of the flowchart.

At step S1506, if a record of connection to the access point APj exists (step S1506: YES), the communications device 101 executes the connection process of connecting to the network via the access point APj (step S1512) and terminates a series of processes of the flowchart.

As a result, if the transition of the display state of the display 303 is made from non-displaying to displaying, the given interval T can be set to the interval T3, which is shorter than the interval T1. Although the interval T3 is an interval that is fixed until the certain time L has elapsed in the description, the interval T3 may be a variable interval made longer for each interval until the certain time L has elapsed (e.g., 10 [seconds]→20 [seconds]→30 [seconds]).

A communication control process (hereinafter referred to as a “third communication control process”) of the communications device 101 will be described that is executed based on a determination result of whether the access point APj is disposed in the cell Ci in which the communications device 101 is present.

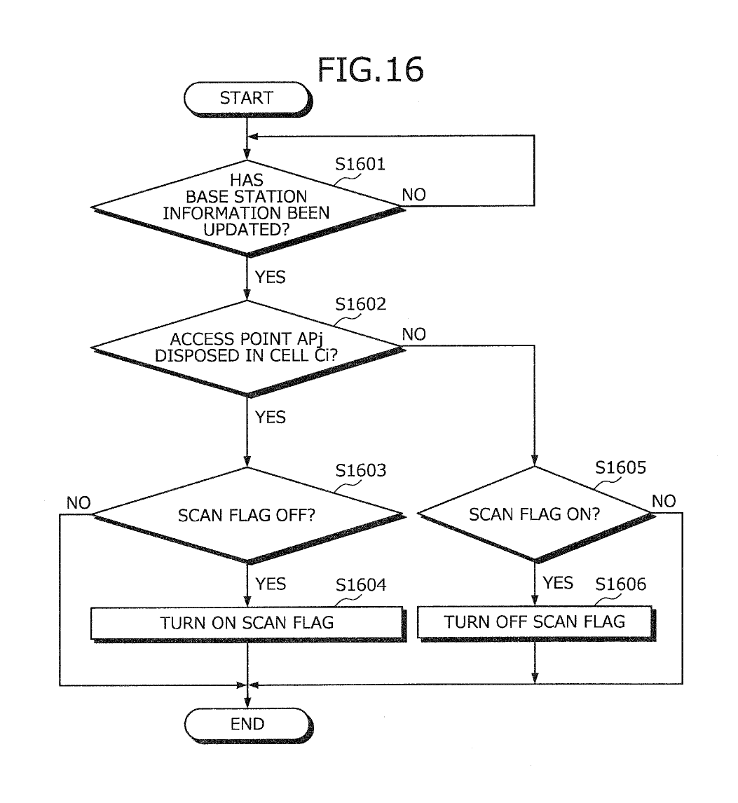

FIG. 16 is a flowchart of an example a scan flag change process procedure of the communications device 101 according to the first embodiment. In the flowchart of FIG. 16, first, the communications device 101 determines whether the base station information received from the base station BSi has been updated (step S1601).

The communications device 101 waits until the base station information has been updated (step S1601: NO). If the base station information has been updated (step S1601: YES), the communications device 101 refers to the AP flag table 500 to decide whether the access point APj is disposed in the cell Ci in which the communications device 101 is present (step S1602).

If the access point APj is disposed (step S1602: YES), the communications device 101 determines whether the scan flag is OFF (step S1603). If the scan flag is ON (step S1603: NO), the communications device 101 terminates a series of processes of the flowchart.

On the other hand, if the scan flag is OFF (step S1603: YES), the communications device 101 changes the scan flag from OFF to ON (step S1604) and terminates a series of processes of the flowchart.

If the access point APj is not disposed at step S1602 (step S1602: NO), the communications device 101 determines whether the scan flag is ON (step S1605). If the scan flag is OFF (step S1605: NO), the communications device 101 terminates a series of processes of the flowchart.

On the other hand, if the scan flag is ON (step S1605: YES), the communications device 101 changes the scan flag from ON to OFF (step S1606) and terminates a series of processes of the flowchart.

As a result, the scan flag can be changed depending on whether the access point APj is set in the cell Ci in which the communications device 101 is present.

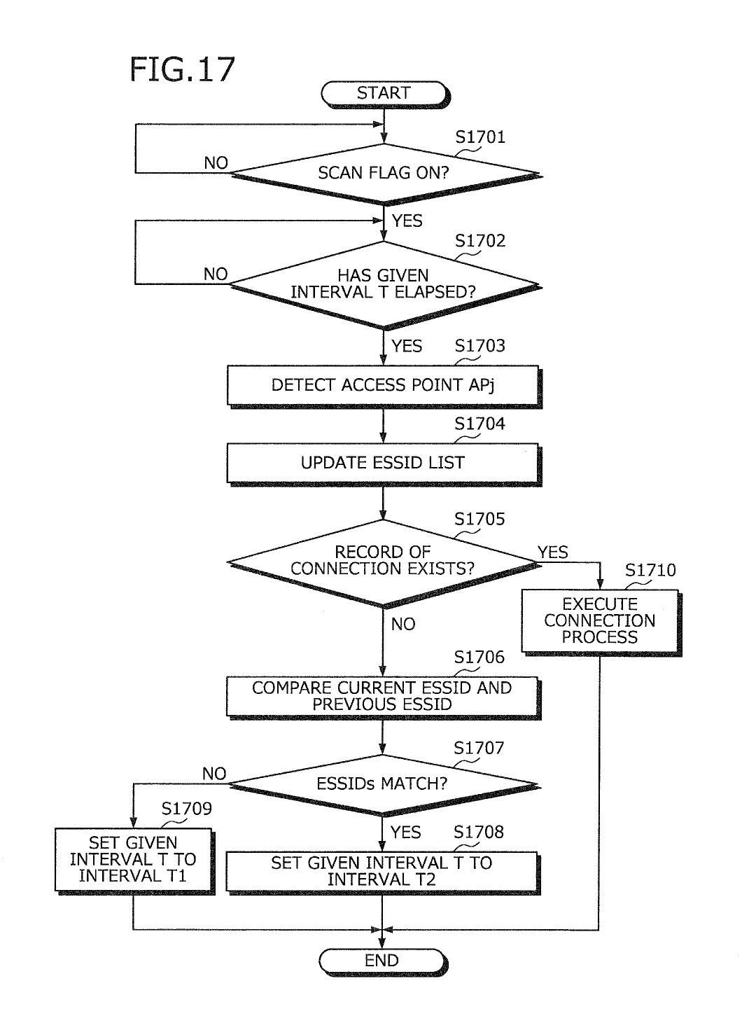

FIG. 17 is a flowchart of an example of a third communication control process procedure of the communications device 101 according to the first embodiment. In the flowchart of FIG. 17, first, the communications device 101 determines whether the scan flag is set to ON (step S1701). The communications device 101 waits until the scan flag is set to ON (step S1701: NO).

If the scan flag is set to ON (step S1701: YES), the communications device 101 determines whether the given interval T of the scanning operation has elapsed (step S1702). The communications device 101 waits until the given interval T of the scanning operation has elapsed (step S1702: NO).

If the given interval T of the scanning operation has elapsed (step S1702: YES), the communications device 101 detects the access point APj (step S1703). The communications device 101 acquires the ESSID of the detected access point APj and updates the storage contents of the ESSID list 600 (step S1704).

The communications device 101 refers to the connection recording table 400 to decide whether a record of connection to the detected access point APj exists (step S1705). If no record of connection to the access point APj exists (step S1705: NO), the communications device 101 refers to the ESSID list 600 to compare the current ESSID with the previous ESSID (step S1706).

The communications device 101 decides whether the current ESSID matches the previous ESSID (step S1707). If the current ESSID matches the previous ESSID (step S1707: YES), the communications device 101 sets the given interval T of the scanning operation to the interval T2 (step S1708) and terminates a series of processes of the flowchart.

On the other hand, if the current ESSID does not match the previous ESSID (step S1707: NO), the communications device 101 sets the given interval T of the scanning operation to the interval T1 (step S1709) and terminates a series of processes of the flowchart.

At step S1705, if a record of connection to the access point APj exists (step S1705: YES), the communications device 101 executes the connection process of connecting via the access point APj to the network (step S1710) and terminates a series of processes of the flowchart.

As a result, if the access point APj is disposed in the cell Ci in which the communications device 101 is present, the detection process can be started to detect the access point APj with the given interval T.

As described above, the communications device 101 according to the first embodiment can detect the access point APj using the given interval T to determine whether the ESSID of the access point APj detected this time matches the ESSID of the access point APj detected last time. As a result, whether the user of the communications device 101 is moving can be decided depending on whether the current ESSI matches the previous ESSID.

If the current ESSID matches the previous ESSID, the communications device 101 can set the given interval T to the interval T2, which is longer than the interval T1 set when the current ESSID does not match the previous ESSID. As a result, if it can be determined that the user is not moving, the number of times of the scanning operation can be reduced as compared to when it can be determined that the user is moving, and the power consumption of the communications device 101 can be suppressed.

If the current ESSID does not match the previous ESSID, the communications device 101 can set the given interval T to the interval T1, which is shorter than the interval T2 set when the current ESSID matches the previous ESSID. As a result, if it can be determined that the user is moving, the scanning operation can be performed using a shorter interval as compared to when it can be determined that the user is not moving, and the re-connectivity to the access point APj can be improved.

If the connection history does not exist for the execution of the connection process of connecting via the detected access point APj to the network, the communications device 101 can make the matching determination between the current ESSID and the previous ESSID. As a result, if the detected access point APj is unavailable, the communications device 101 can execute the sequence of changing the given interval T of the scanning operation.

If the connection history exists for the execution of the connection process of connecting to the network, via the detected access point APj, the communications device 101 can execute the connection process to the detected access point APj. As a result, if an available access point APj is detected, the communications device 101 can execute the connection process to the detected access point APj without operational input performed by a user.

If the transition of the display state of the display 303 is made from non-displaying to displaying, the communications device 101 can set the given interval T to the interval T3, which is shorter than the interval T1. As a result, the re-connectivity to the access point APj can be improved at the time of screen-ON.

If the communication software is activated, the communications device 101 can set the given interval T to the interval T3. As a result, the re-connectivity to the access point APj can be improved at the time of execution of the communication application.

The communications device 101 can make the matching determination between the current ESSID and the previous ESSID after the certain time L has elapsed since a setting of the given interval T to the interval T3. As a result, the sequence of changing the given interval T of the scanning operation can be executed after waiting until the certain time L has elapsed since screen-ON so as to ensure the re-connectivity to the access point APj at the time of screen-ON. The sequence of changing the given interval T of the scanning operation can be executed after waiting until the certain time L has elapsed from the start of execution of the communication application so as to ensure the re-connectivity to the access point APj at the start of execution of the communication application.

If the access point APj is disposed in the cell Ci in which the communications device 101 is present, the communications device 101 can start the detection process of detecting the access point APj with the given interval T. As a result, the communications device 101 can reduce the power consumption required for the scanning operation when the access point APj is not present in the cell Ci in which the communications device 101 is present.

The communications device 101 according to a second embodiment will be described. The portions identical to those described in the first embodiment will not be described.

In the second embodiment, if the ESSID of the access point APj detected in the periodic scanning operation is the same as that of the previous period, the communications device 101 decides that the user is not moving, and reduces the number of frequencies (channels) used for wireless communication with the access point APj. As a result, the power consumption for one scanning operation is reduced.

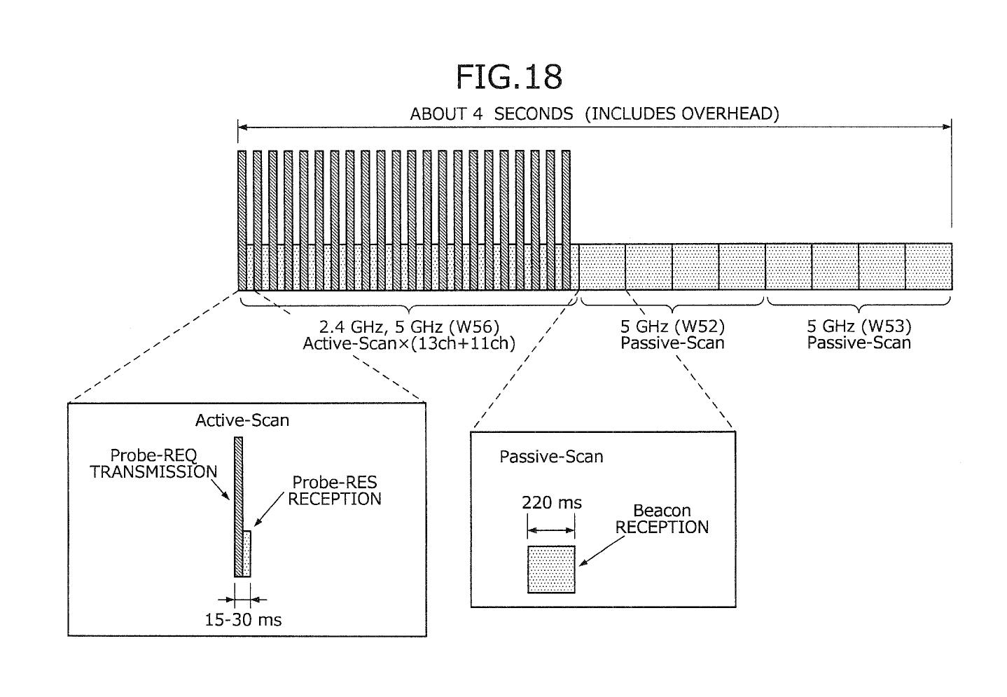

The scanning operation of detecting the access point APj will be described. FIG. 18 is an explanatory diagram of an example of the scanning operation of detecting the access point APj. As depicted in FIG. 18, the scanning operation includes active scan and passive scan.

The active scan is a scanning operation of detecting the access point APj by transmitting a probe response signal to each channel used for a wireless LAN and receiving a probe response signal. The active scan uses a frequency band of 2.4 [GHz] and a frequency band of 5 [GHz], for example.

For example, the wireless LAN channels used in the active scan include 13 channels in the frequency band of 2.4 [GHz] of The Institute of Electrical and Electronics Engineers, Inc. (IEEE) 802.11 and 11 channels of W56 (type) of IEEE 802.11.

The passive scan is a scanning operation of detecting the access point APj by receiving a signal (packet) called a beacon from the access point APj. The passive scan uses a frequency band of 5 [GHz], for example. For example, the wireless LAN channels used in the passive scan include 4 channels of W52 (type) and 4 channels of W53 (type) of IEEE 802.11.

Time required for the active scan of one channel is about 15 to 30 [ms], for example. Time required for the passive scan of one channel is about 220 [ms], for example. Since the interval of transmission of the beacon from the access point APj is about 102.4 [ms], the time is ensured such that the beacon can be received twice.

If both the active scan and the passive scan are performed, the communications device 101 first performs the active scan and then performs the passive scan, for example. The time required for both the active scan of 24 channels (13+11 channels) and the passive scan of 8 channels is about 4 [seconds], for example. The passive scan includes maintaining the standby state for receiving the beacon from the access point APj and therefore, tends to increase power consumption as compared to the active scan.

In the following description, 24 channels (13+11 channels) used in the active scan are denoted by “1ch to 24ch” and 8 channels used in the passive scan are denoted by “25ch to 32ch” in some cases for convenience.

A functional configuration example of the communications device 101 according to the second embodiment will be described. The functional units identical to those of the communications device 101 described in the first embodiment are denoted by the same reference numerals used on the first embodiment and description thereof will be omitted, and the functional units different from the communications device 101 described in the first embodiment will be described.

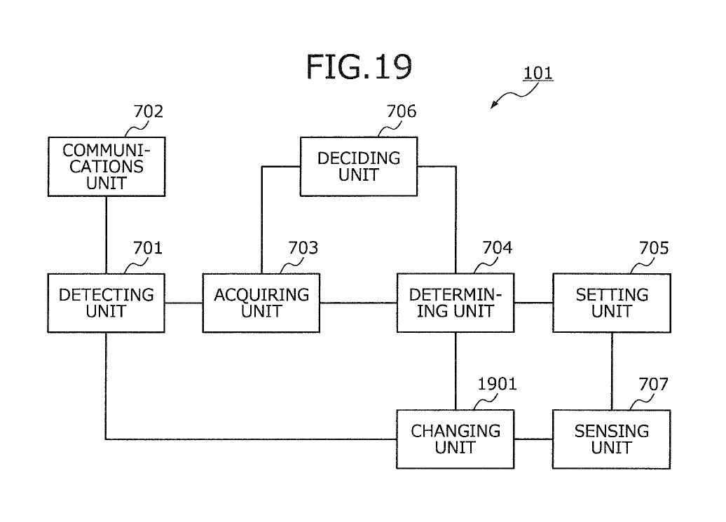

FIG. 19 is a block diagram of a functional configuration of the communications device 101. In FIG. 19, the communications device 101 has a configuration including the detecting unit 701, the communications unit 702, the acquiring unit 703, the determining unit 704, the setting unit 705, the deciding unit 706, the sensing unit 707, and a changing unit 1901. The detecting unit 701 to the sensing unit 707 and the changing unit 1901 are functions acting as a control unit and, for example, are implemented by causing the CPU 301 to execute a program stored in the memory 302 depicted in FIG. 3, or by the WLAN communications unit 307. The functions may be implemented by causing the arithmetic circuit of the WLAN communications unit 307 to execute a program stored in the memory of the WLAN communications unit 307, or by the WLAN I/F of the WLAN communications unit 307. Processing results of the functional units are stored in the memory 302 and the memory of the WLAN communications unit 307, for example.

The changing unit 1901 has a function of changing the frequency of a signal used for wireless communication with the access point APj, based on the determination result obtained by the determining unit 704. For example, if the current ESSID matches the previous ESSID, the changing unit 1901 changes the number of channels used for the wireless communication with the access point APj to a number of channels less than that when the current ESSID does not match the previous ESSID.

For example, it is assumed that all the channels “1ch to 32ch” used for the wireless communication with the access point APj are set by default. In this case, for example, if the current ESSID matches the previous ESSID and the ESSID is obtained from the access point APj by using a channel among “1ch to 24ch”, the changing unit 1901 may change the channels used for the wireless communication with the access point APj from “1ch to 32ch” to “1ch to 24ch”. In other words, if it can be determined that the user of the communications device 101 is not moving, the channels (25ch to 32ch) used for the passive scan, which consumes more power than the active scan, are excluded from the channels to be scanned.

For example, if the current ESSID does not match the previous ESSID, the changing unit 1901 changes the number of channels used for the wireless communication with the access point APj to a number of channels greater than that when the current ESSID matches the previous ESSID. For example, it is assumed that the channels “1ch to 24ch” used for the wireless communication with the access point APj are set.

In this case, for example, if the current ESSID does not match the previous ESSID, the changing unit 1901 changes the channels used for the wireless communication with the access point APj back to the default setting. In other words, if it can be determined that the user of the communications device 101 is moving, the channels (25ch to 32ch) excluded from the channels to be scanned are set again as the channels to be scanned.

The detecting unit 701 has a function of detecting the wirelessly connecting access point APj using the given interval T, by using the changed frequency changed by the changing unit 1901. For example, if the channels used for the wireless communication with the access point APj are changed to “1ch to 24ch”, the detecting unit 701 performs only the active scan.

As a result, if the user of the communications device 101 is not moving, the communications device 101 can refrain from performing the passive scan so as to reduce the power consumption required for the passive scan.

For example, if the current ESSID matches the previous ESSID, the changing unit 1901 may change the channels used for the wireless communication to the channel used for the wireless communication with the access point of the ESSID matching the previous ESSID. For example, if the current and previous matching ESSIDs are acquired through the wireless communication using the same channel, the changing unit 1901 changes the channel used for the wireless communication to the channel through which the ESSIDs are acquired.

For example, it is assumed that “1ch” is the channel used for the wireless communication with the access point of the ESSID matching the previous ESSID. In this case, for example, the changing unit 1901 may change the channel used for the wireless communication with the access point APj to “1ch”. In this case, the detecting unit 701 controls the communications unit 702 to transmit the probe request signal to 1ch (unicast).

For example, it is assumed that “1ch and 7ch” are the channels used for the wireless communication with the access point of the ESSID matching the previous ESSID. In this case, for example, the changing unit 1901 may change the channel used for the wireless communication with the access point APj to “1ch and 7ch”. In this case, the detecting unit 701 controls the communications unit 702 to transmit the probe request signal to 1ch and 7ch (multicast).

As a result, if the user of the communications device 101 is not moving, the scanning operation can be performed merely for the access point APj detected in the previous period and the power consumption for the scanning operation can be suppressed.

If the sensing unit 707 senses the transition of the display state from non-displaying to displaying, the changing unit 1901 may change the frequency of signals used for the wireless communication with the access point APj based on the determination result determined by the determining unit 704. As a result, the power consumption required for the scanning operation performed using the interval T3 can be suppressed at the time of screen-ON.

If the sensing unit 707 senses the activation of the communication application, the changing unit 1901 may change the frequency of signals used for the wireless communication with the access point APj based on the determination result determined by the determining unit 704. As a result, the power consumption required for the scanning operation performed with the interval T3 can be suppressed at the time of activation of a browser.

Although the communications device 101 according to the second embodiment has the setting unit 705 in the description, the communications device 101 according to the second embodiment may omit the setting unit 705

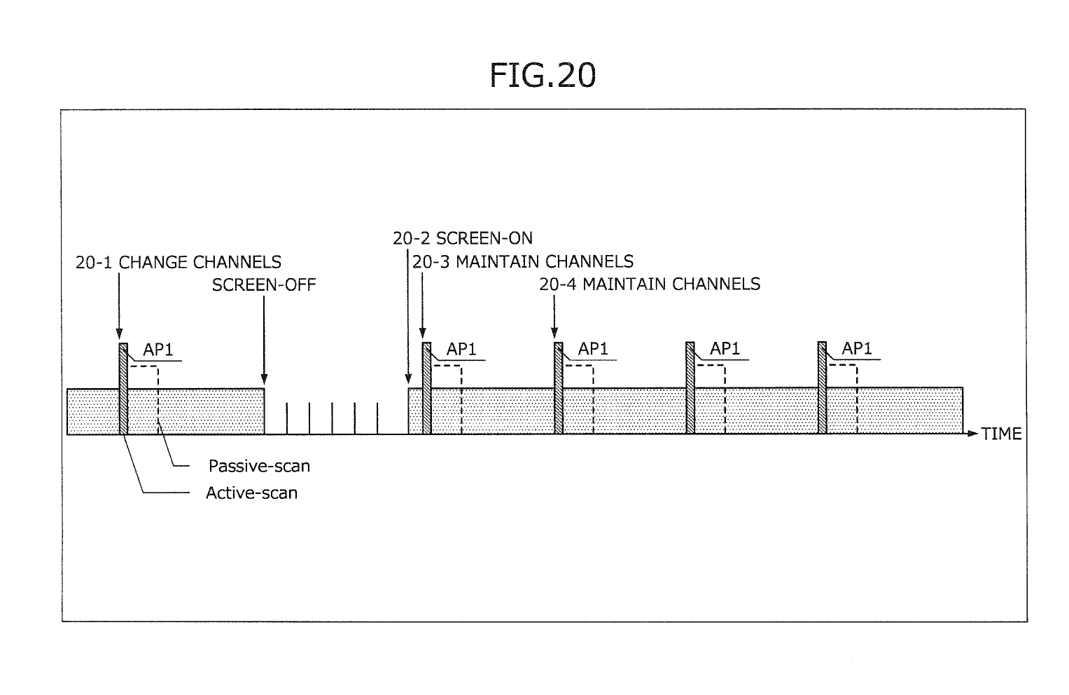

An operation example of the communications device 101 according to the second embodiment will be described with reference to FIGS. 20 to 23.

FIG. 20 is an explanatory diagram (part one) of an operation example of the communications device 101 according to the second embodiment. In FIG. 20, as indicated by ‘20-1’, as a result of detection of the access point Apj, if the current ESSID matches the previous ESSID and any channel of “1ch to 24ch” is used for acquiring the ESSID from the access point Apj, the communications device 101 changes the channels used for the wireless communication with the access point Apj from “1ch to 32ch” to “1ch to 24ch”.

As a result, in the scanning operation of detecting the access point APj, the active scan alone is performed among the active scan and the passive scan. In the example depicted in FIG. 20, the transition of the display state of the display 303 is subsequently made from displaying to non-displaying.

As indicated by ‘20-2’, the communications device 101 senses that the transition of the display state of the display 303 is made from non-displaying to displaying. As indicated by ‘20-3’, as a result of detection of the access point Apj, if the current ESSID matches the previous ESSID, the communications device 101 changes the channels used for the wireless communication with the access point Apj from “1ch to 32ch” to “1ch to 24ch”.

In the example depicted in FIG. 20, the current ESSID “AP1” matches the previous ESSID “AP1” and the channels used for the wireless communication with the access point Apj are already changed from “1ch to 32ch” to “1ch to 24ch”. Therefore, the communications device 101 maintains the changed channels.

As indicated by ‘20-4’, as a result of detection of the access point Apj after the given interval T has elapsed, if the current ESSID matches the previous ESSID, the communications device 101 changes the channels used for the wireless communication with the access point Apj from “1ch to 32ch” to “1ch to 24ch”.

In the example depicted in FIG. 20, the current ESSID “AP1” matches the previous ESSID “AP1” and the channels used for the wireless communication with the access point Apj are already changed from “1ch to 32ch” to “1ch to 24ch”. Therefore, the communications device 101 maintains the changed channels.

As described above, if it can be determined that the user of the communications device 101 is not moving, the communications device 101 can refrain from performing the passive scan to reduce the power consumption required for the scanning operation.

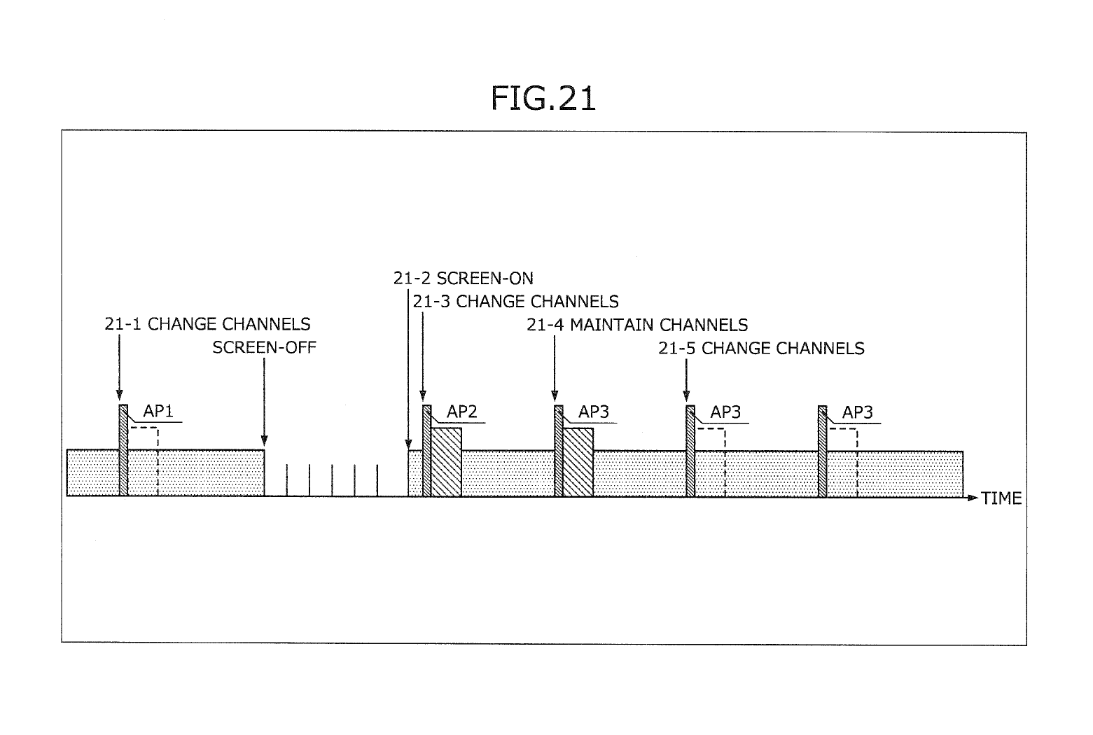

FIG. 21 is an explanatory diagram (part one) of an operation example of the communications device 101 according to the second embodiment. In FIG. 21, as indicated by ‘21-1’, as a result of detection of the access point Apj, if the current ESSID matches the previous ESSID and any channel of “1ch to 24ch” is used for acquiring the ESSID from the access point Apj, the communications device 101 changes the channels used for the wireless communication with the access point Apj from “1ch to 32ch” to “1ch to 24ch”.

As a result, in the scanning operation of detecting the access point APj, the active scan alone is performed among the active scan and the passive scan. In the example depicted in FIG. 21, the transition of the display state of the display 303 is subsequently made from displaying to non-displaying.

As indicated by ‘21-2’, the communications device 101 senses that the transition of the display state of the display 303 is made from non-displaying to displaying. As indicated by ‘21-3’, as a result of detection of the access point Apj, if the current ESSID does not match the previous ESSID, the communications device 101 changes the channels used for the wireless communication with the access point Apj to the default setting.

In the example depicted in FIG. 21, since the current ESSID “AP2” does not match the previous ESSID “AP1”, the channels used for the wireless communication with the access point Apj are changed from “1ch to 24ch” to “1ch to 32ch”. As a result, the active scan and the passive scan are performed in the scanning operation of detecting the access point APj.

As indicated by ‘21-4’, as a result of detection of the access point Apj after the given interval T has elapsed, if the current ESSID does not match the previous ESSID, the communications device 101 changes the channels used for the wireless communication with the access point Apj to the default setting.

In the example depicted in FIG. 21, the current ESSID “AP3” does not match the previous ESSID “AP2” and the channels used for the wireless communication with the access point Apj are already changed to “1ch to 32ch”. Therefore, the communications device 101 maintains the changed channels.

As indicated by ‘21-4’, as a result of detection of the access point Apj after the given interval T has elapsed, if the current ESSID matches the previous ESSID, the communications device 101 changes the channels used for the wireless communication with the access point Apj from “1ch to 32ch” to “1ch to 24ch”.

In the example depicted in FIG. 21, the current ESSID “AP3” matches the previous ESSID “AP3” and therefore, the channels used for the wireless communication with the access point Apj are already changed from “1ch to 32ch” to “1ch to 24ch”. As a result, in the scanning operation of detecting the access point APj, the active scan and the passive scan are performed.

As described above, if it can be determined that the user of the communications device 101 is moving, the communications device 101 can change the channels used for the wireless communication with the access point APj back to the default setting. As a result, if the user is moving, the re-connectivity to the access point APj can be improved by performing both the active scan and the passive scan.

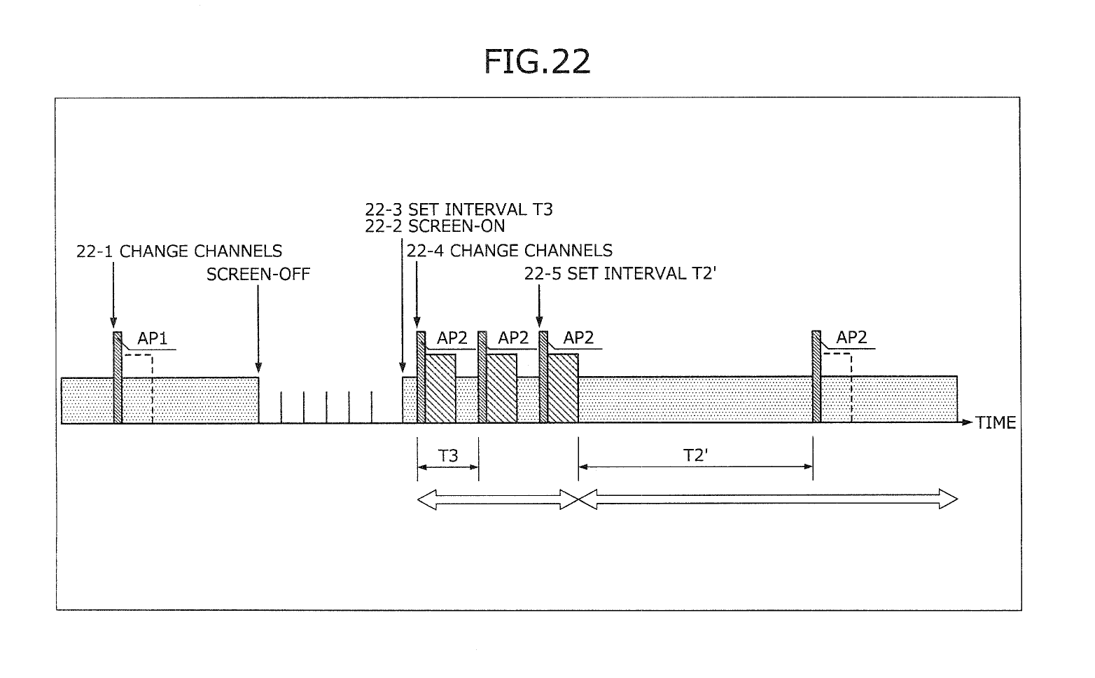

FIG. 22 is an explanatory diagram (part three) of an operation example of the communications device 101 according to the second embodiment. In FIG. 22, as indicated by ‘22-1’, as a result of detection of the access point Apj, if the current ESSID matches the previous ESSID and any channel among “1ch to 24ch” is used for acquiring the ESSID from the access point Apj, the communications device 101 changes the channels used for the wireless communication with the access point Apj from “1ch to 32ch” to “1ch to 24ch”.

As a result, in the scanning operation of detecting the access point APj, only the active scan is performed among the active scan and the passive scan. In the example depicted in FIG. 22, the transition of the display state of the display 303 is subsequently made from displaying to non-displaying.

As indicated by ‘22-2’, the communications device 101 senses that the transition of the display state of the display 303 is made from non-displaying to displaying. As indicated by ‘22-3’, if the transition is made from non-displaying to displaying, the communications device 101 sets the given interval T to the interval T3. As a result, the scanning operation for the access point APj is performed using the interval T3.

As indicated by ‘22-4’, as a result of detection of the access point Apj, if the current ESSID does not match the previous ESSID, the communications device 101 changes the channels used for the wireless communication with the access point Apj to the default setting.

In the example depicted in FIG. 22, since the current ESSID “AP2” does not match the previous ESSID “AP1”, the channels used for the wireless communication with the access point Apj are changed from “1ch to 24ch” to “1ch to 32ch”. Therefore, the active scan and the passive scan are performed in the scanning operation of detecting the access point APj.

As indicated by ‘22-5’, if the connection to the access point APj is not completed after the scanning operation is performed three times, the communications device 101 sets the given interval T to the interval T2′. In other words, if the connection to the access point APj cannot be achieved after the scanning operation is performed three times, it is unlikely that the communications device 101 can subsequently connect to the access point APj and therefore, the communications device 101 sets the given interval T to the interval T2′ longer than the interval T3. As a result, the scanning operation for the access point APj is performed with the interval T2′.

As described above, if it can be determined that the user of the communications device 101 is moving, the communications device 101 can change the channels used for the wireless communication with the access point APj back to the default setting. As a result, if the user is moving, the re-connectivity to the access point APj can be improved by performing both the active scan and the passive scan. If the connection to the access point APj is not completed after the scanning operation is performed three times, the communications device 101 can set the given interval T to the interval T2′ to suppress the power consumption required for the scanning operation.

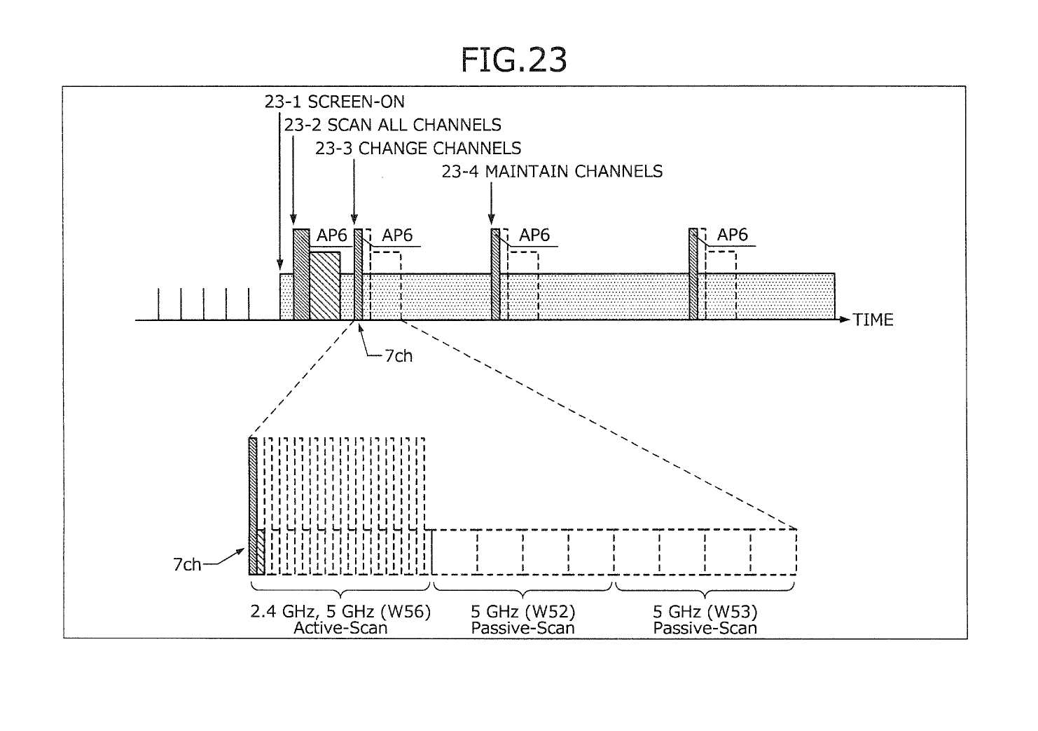

FIG. 23 is an explanatory diagram (part four) of an operation example of the communications device 101 according to the second embodiment. In FIG. 23, as indicated by ‘23-1’, the communications device 101 senses that the transition of the display state of the display 303 is made from non-displaying to displaying. As indicated by ‘23-2’, if the transition of the display state is made from non-displaying to displaying, the communications device 101 performs the scanning operation so that all the channels of 1ch to 32ch are to be scanned.

Therefore, the re-connectivity to the access point APj can be improved immediately after screen-ON. As a result, in the example depicted in FIG. 23, the access point AP6 is detected through the wireless communication using 7ch.

As indicated by ‘23-3’, if the current ESSID matches the previous ESSID as a result of detection of the access point Apj, the communications device 101 changes the channels used for the wireless communication to the channel used for the wireless communication with the access point of the ESSID matching the previous ESSID.

In the example depicted in FIG. 23, the current ESSID “AP6” matches the previous ESSID “AP6”. The ESSID “AP6” of the access point AP6 is acquired both this time and last time through the wireless communication using the same 7ch. Therefore, the channel used for the wireless communication is changed to 7ch. As a result, in the scanning operation of detecting the access point APj, only the active scan through 7ch is performed among the active scan and the passive scan.

As indicated by ‘23-4’, as a result of detection of the access point Apj after the given interval T has elapsed, if the current ESSID matches the previous ESSID, the communications device 101 changes the channels used for the wireless communication to the channel used for the wireless communication with the access point of the ESSID matching the previous ESSID.

In the example depicted in FIG. 23, the current ESSID “AP6” matches the previous ESSID “AP6”. The ESSID “AP6” of the access point AP6 is acquired both this time and last time through the wireless communication using the same 7ch. The channel used for the wireless communication is already changed to 7ch. Therefore, the communications device 101 maintains the changed channel.

As described above, if the same ESSID is acquired through the same channel as the previous time, the communications device 101 can change the channel used for the wireless communication with the access point APj to the channel. As a result, if it can be determined that the user of the communications device 101 is not moving, only the active scan using the certain channel is performed and the power consumption required for the scanning operation can be reduced.

Various process procedures of the communications device 101 according to the second embodiment will be described.

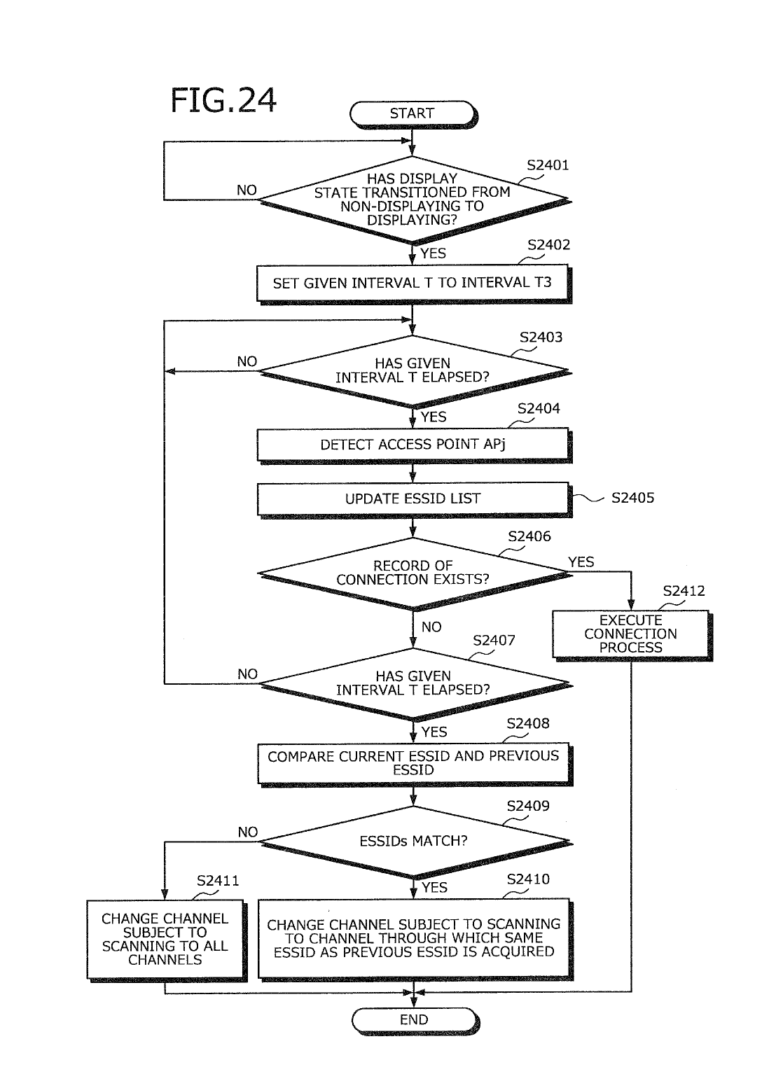

FIG. 24 is a flowchart of an example of a second communication control process procedure of the communications device 101 according to the second embodiment. In the flowchart of FIG. 24, first, the communications device 101 decides whether the transition of the display state of the display 303 is made from non-displaying to displaying (step S2401).

The communications device 101 waits until the transition of the display state of the display 303 is made from non-displaying to displaying (step S2401: NO). If the transition of the display state of the display 303 is made from non-displaying to displaying (step S2401: YES), the communications device 101 sets the given interval T of the scanning operation to the interval T3 (step S2402).

The communications device 101 decides whether the given interval T of the scanning operation has elapsed (step S2403). The communications device 101 waits until the given interval T of the scanning operation has elapsed (step S2403: NO). If the given interval T of the scanning operation has elapsed (step S2403: YES), the communications device 101 detects the access point APj (step S2404).

The communications device 101 acquires the ESSID of the detected access point APj and updates the storage contents of the ESSID list 600 (step S2405). The communications device 101 refers to the connection recording table 400 to decide whether a record of connection to the detected access point APj exists (step S2406).

If no record of connection to the access point APj exists (step S2406: NO), the communications device 101 decides whether the certain time L has elapsed after the transition of the display state of the display 303 is made from non-displaying to displaying (step S2407). If the certain time L has not elapsed (step S2407: NO), the communications device 101 returns to step S2403.

On the other hand, if the certain time L has elapsed (step S2407: YES), the communications device 101 refers to the ESSID list 600 to compare the current ESSID with the previous ESSID (step S2408). The communications device 101 decides whether the current ESSID matches the previous ESSID (step S2409).

If the current ESSID matches the previous ESSID (step S2409: YES), the communications device 101 changes the channel subject to scanning to the channel through which the same ESSID as the previous ESSID is acquired (step S2410) and terminates a series of processes of the flowchart.

On the other hand, if the current ESSID does not match the previous ESSID (step S2409: NO), the communications device 101 changes the channel subject to scanning to all channels that can be set as a channel subject to scanning (step S2411) and terminates a series of processes of the flowchart.

At step S2406, if a record of connection to the access point APj exists (step S2406: YES), the communications device 101 executes the connection process of connecting to the network, via the access point APj (step S2412) and terminates a series of processes of the flowchart.

As a result, if the current ESSID matches the previous ESSID, the number of channels used for the wireless communication with the access point APj can be reduced. If the current ESSID does not match the previous ESSID, the channels used for the wireless communication with the access point APj can be changed back to the default setting.

Although the channels to be scanned are changed at step S2410 to the channels through which the ESSID same as the previous ESSID is acquired in the above description, this is not a limitation. For example, if any channel of “1ch to 24ch” is used for acquiring the ESSID from the access point Apj, the communications device 101 may change the channels to be scanned to the channels used for the active scan (1ch to 24ch).

If the current ESSID matches the previous ESSID at step S2409, the communications device 101 may set the given interval T of the scanning operation to the interval T2′. If the current ESSID does not match the previous ESSID at step S2409, the communications device 101 may set the given interval T of the scanning operation to the interval T1′.

As described above, the communications device 101 according to the second embodiment can detect the access point APj with the given interval T to determine whether the ESSID of the access point APj detected this time matches the ESSID of the access point APj detected last time. As a result, whether the user of the communications device 101 is moving can be decided depending on whether the current ESSI matches the previous ESSID.

If the current ESSID matches the previous ESSID, the communications device 101 can set the number of channels used for the wireless communication with the access point APj to the number of channels smaller than that when the current ESSID does not match the previous ESSID. As a result, if it can be determined that the user is not moving, the number of channels to be scanned can be reduced from the default setting, and the power consumption required for the scanning operation can be suppressed.

If the current ESSID does not match the previous ESSID, the communications device 101 can set the number of channels used for the wireless communication with the access point APj to the number of channels larger than that when the current ESSID matches the previous ESSID. As a result, if it can be determined that the user is moving, the number of channels to be scanned can be changed back to the default setting, and the re-connectivity to the access point APj can be ensured.

If the current ESSID matches the previous ESSID, the communications device 101 can change the channels used for the wireless communication with the access point APj to the channel used for the wireless communication with the access point of the current ESSID matching the previous ESSID. As a result, if it can be determined that the user is not moving, the scanning operation can be performed only for the access point APj detected in the previous period and the power consumption required for the scanning operation can be suppressed.

The communication control method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

An aspect of the present invention produces an effect that power consumption can be suppressed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communications device comprising
a processor configured to:
detect a wirelessly communicating base station, using a given interval;
determine whether identification information of the detected base station matches identification information of a base station detected last time; and
set the given interval to a second interval upon determining that the identification information of the detected base station and the identification information of the base station detected last time match, the second interval being longer than a first interval that is set upon determining that the identification information of the detected base station and the identification information of the base station detected last time do not match.

2. The communications device according to claim 1, wherein
the processor sets the given interval to the first interval upon determining that the identification information of the detected base station and the identification information of the base station detected last time do not match.

3. The communications device according to claim 1, wherein
the processor is further configured to decide whether connection history exists for execution of a connection process of connecting to a network via the detected base station, and
the processor, upon deciding that the connection history does not exist, determines whether the identification information of the detected base station matches the identification information of the base station detected last time.

4. The communications device according to claim 3, wherein
the processor is further configured to control a communications unit configured to communicate with the base station, the processor controlling the communications unit to execute the connection process of connecting to the detected base station, upon deciding that the connection history exists.

5. The communications device according to claim 3, wherein
the processor decides whether the base station is disposed in a communication area in which the communications device is present, based on information identifying a communication area in which the base station is disposed and among a communication area group of other base stations that are detected by a detection operation different from the base station and have a communicable range greater than the base station, and
the processor starts the detection process of detecting the base station, using the given interval, upon deciding that the base station is disposed in the communication area in which the communications device is present.

6. The communications device according to claim 1, wherein
the processor, if multiple records of the identification information of the base station detected last time are present, determines whether the identification information of the detected base station matches at least any one of the multiple records of the identification information detected last time.

7. The communications device according to claim 1, wherein
the process is further configured to sense a transition of a display state of a screen from non-displaying to displaying, and
the processor sets the given interval to a third period that is shorter than the first interval, upon sensing the transition of the display state from non-displaying to displaying.

8. The communications device according to claim 7, wherein
the processor senses activation of software that causes communication with another apparatus during execution, and
the processor sets the given interval to the third period, upon sensing the activation of the software.

9. The communications device according to claim 7, wherein
the processor determines after a certain time has elapsed since setting the given interval to the third period, whether the identification information of the detected base station matches the identification information of the base station detected last time.

10. The communications device according to claim 1, wherein
the processor is further configured to change based on an obtained determination result, a frequency of a signal that is used for wireless communication with the base station, and
the processor uses the given interval and the frequency of the signal after changing the frequency, to detect the base station.

11. A communications device comprising
a processor configured to:
detect a wirelessly communicating base station, using a given interval;
determine whether identification information of the detected base station matches identification information of a base station detected last time; and
change a frequency of a signal used for wireless communication with the base station, based on an obtained determination result, wherein
the processor detects the base station by using the given interval and the frequency of the signal after changing the frequency.

12. A non-transitory, computer-readable recording medium storing a communication control program that causes a computer to execute a process comprising:
detecting a wirelessly communicating base station, using a given interval;
determining whether identification information of the detected base station matches identification information of a base station detected last time; and
setting the given interval to a second interval upon determining that the identification information of the detected base station and the identification information of the base station detected last time match, the second interval being longer than a first interval that is set upon determining that the identification information of the detected base station and the identification information of the base station detected last time do not match.

13. A non-transitory, computer-readable recording medium storing a communication control program that causes a computer to execute a process comprising:
detecting a wirelessly communicating base station, using a given interval;
determining whether identification information of the detected base station matches identification information of a base station detected last time;
changing a frequency of a signal used for wireless communication with the base station, based on an obtained determination result; and
detecting the base station by using the given interval and the frequency of the signal after changing the frequency.

14. A communication control method comprising:
detecting, by a computer, a wirelessly communicating base station, using a given interval;
determining, by the computer, whether identification information of the detected base station matches identification information of a base station detected last time; and
setting, by the computer, the given interval to a second interval upon determining that the identification information of the detected base station and the identification information of the base station detected last time match, the second interval being longer than a first interval that is set upon determining that the identification information of the detected base station and the identification information of the base station detected last time do not match.

15. A communication control method comprising:
detecting, by a computer, a wirelessly communicating base station, using a given interval;
determining, by the computer, whether identification information of the detected base station matches identification information of a base station detected last time;
changing, by the computer, a frequency of a signal used for wireless communication with the base station, based on an obtained determination result; and
detecting, by the computer, the base station by using the given interval and the frequency of the signal after changing the frequency.
